(19) United States
(12) Patent Application Publication
(10) Pub. No.: US 2026/0283360 A1
(43) Pub. Date: Sep. 24, 2026

(54) SEAT AND SEAT SYSTEM

(71) Applicant: TS TECH CO., LTD., Asaka-shi, Saitama (JP)

(72) Inventors: Takuya OZAKI, Shioya-gun, Tochigi (JP); Takayoshi ITO, Shioya-gun, Tochigi (JP); Yuki YOSHIOKA, Shioya-gun, Tochigi (JP); Kotaro TOMIOKA, Shioya-gun, Tochigi (JP); Minako OYA, Shioya-gun, Tochigi (JP)

(21) Appl. No.: 19/168,069

(22) PCT Filed: Jun. 13, 2024
(86) PCT No.: PCT/JP2024/021478

§ 371 Date: Sep. 23, 2025

Related U.S. Application Data
(60) Provisional application No. 63/511,938, filed on Jul. 5, 2023.

(30) Foreign Application Priority Data
Aug. 25, 2023 (JP) 2023-137055
Aug. 25, 2023 (JP) 2023-137056
Sep. 28, 2023 (JP) 2023-166653

(51) Int. Cl. A47C 7/14; A47C 7/46; A47C 7/72; A47C 7/74; B60N 2/56; B60N 2/90

(52) U.S. Cl. CPC A47C 7/142; A47C 7/467; A47C 7/723; A47C 7/74; B60N 2/56; B60N 2/90

(57) ABSTRACT

A seat includes a first electric device configured to operate when energized, a second electric device configured to operate when energized, a first operation unit configured to operate the first electric device, and a controller configured to operate the first electric device based on a first operation command from the first operation unit. The controller is configured to select and execute a first control, in response to receiving the first operation command from the first operation unit, in which the controller operates the first electric device in a first operation state corresponding to the first operation command, and a second control, in response to receiving the first operation command from the first operation unit, in which the controller operates the first electric device in a second operation state that does not correspond to the first operation command and/or operates the second electric device.

### TECHNICAL FIELD

The present invention relates to a seat comprising an electric device and a seat system comprising a seat.

### BACKGROUND ART

Conventionally, a technology is known for moving a user's seat in synchronization with an action of a character in augmented reality performing an action for pulling the user's seat toward itself (JP 2020-042334 A).

### SUMMARY OF INVENTION

However, in such well-known art, the entire seat just moves in synchronization with the movement of the character, and it is difficult for the user to feel the presence of the character.

It is desirable for the user to feel the presence of the character more easily.

In light of the above-described background, a seat system including a seat for a user to be seated, an electric device that moves a predetermined portion that is a portion of the seat, a controller that controls the electric device, and a display is disclosed.

The controller is configured to display a seat image representing the seat and a character image on the display. The controller executes an image-seat linking process in which the controller displays a seat image representing the seat and a character image on the display, and moves the predetermined portion by the electric device in synchronization with an action of the character image.

According to this configuration, when the character image performs an action on the portion of the seat image, the portion of the seat is moved by the electric device; therefore, the user can feel the presence of the character more easily. In more detail, for example, since the electric device pushes a portion of the seat when the character image pushes a portion of the seat image, the user feels as if the character is pushing the user via the seat, enabling interaction with the character via the seat.

The character image may be an image representing an animal.

According to this configuration, since the user can interact with the animal via the seat, a soothing effect can be achieved. If the animal is an animal smaller than the seat, the user can feel the presence of the animal in the vicinity of a portion of the seat by causing the electric device to move the seat.

The seat may include a seat cushion and a seat back as a predetermined portion. The electric device may be an electric reclining mechanism that tilts the seat rearward, and, when the character image tilts a portion of the seat corresponding to the seat rearward, the controller may cause the electric reclining mechanism to tilt the seat back rearward.

The seat may include a seat cushion and a seat back. The predetermined portion may be at least a portion of a seating surface of the seat cushion, the electric device may be a device that moves the predetermined portion upward, and, when the character image pushes up a portion of the seat image corresponding to the predetermined portion, the controller may move the predetermined portion upward by the electric device.

The predetermined portion may be a part of the seating surface of the seat, the electric device may move the predetermined portion between a first position and a second portion further toward the user side, and, when the character image repeatedly moves the portion of the seat image corresponding to the predetermined portion, the controller may cause the electric device to move the predetermined portion between the first position and the second position.

The seat may include a heater and the controller may display the character at a position corresponding to the heater and cause the heater to operate.

According to this configuration, since the heater heats a portion of the seat corresponding to a position of the seat image at which the character is present, the user may feel the body temperature of the character via the seat.

The controller may execute the image-seat linking process in response to an operation command for operating the electric device being input.

The controller may execute the image-seat linking process when the operation command is not received and a condition other than the operation command is satisfied.

In light of the above-described background, the vehicle including a seat system and a driving state detecting unit that detects the driving state of the vehicle is disclosed.

The controller acquires the driving state from the driving state detection unit, and limits the operation of the electric device based on the acquired driving state.

According to this configuration, since the controller limits the operation of the electric device based on the driving state, comfort of the seat can be increased by limiting the operation of the electric device when in a driving state that may make the user feel sick if the electric device is operated, such as when the vehicle is traveling along a curve.

The vehicle may include a road condition detecting unit that detects a road condition, and the controller may limit the operation of the electric device based on the road condition.

According to this configuration, since the controller limits the operation of the electric device based on the road condition, comfort of the seat can be increased by limiting the operation of the electric device when the road condition is a condition that may make the user feel sick if the electric device is operated, such as when the vehicle is stopping at a slope.

Further, conventionally, a seat system known in the art includes an electric sliding mechanism that slides the seat in the front-rear direction, a front switch for commanding the seat to be moved forward, a rear switch for commanding the seat to be moved rearward, and a controller configured to cause the seat to move in the direction intended by the user based on the command from the front switch or the rear switch (JP 2022-185254 A).

However, in the prior art, the seat can only be moved in the direction the intended by the user, which lacks entertainment.

It is desirable to increase the entertainment value of a seat and a seat system including an electric device and an operation unit that operates the electric device.

In light of the above-described background a seat in one aspect includes a first electric device configured to operate when energized, a second electric device configured to operate when energized, a first operation unit configured to operate the first electric device, and a controller that operates the first electric device based on a first operation command from the first operation unit.

The controller selects and executes a first control, in response to receiving the first operation command, in which the controller operates the first electric device in a first operation state corresponding to the first operation command from the first operation unit and a second control, in response to receiving the first operation command from the first operation unit, in which the controller operates the first electric device in a second operation state that does not correspond to the first operation command and/or operates the second electric device.

According to this configuration, since at least one of the first electric device or the second electric device assumes an operation state not intended by the user in response to the user operating the operation unit when the controller executes the second control, the entertainment value can be increased.

The first electric device may be a mechanism configured to move a movable part between a first position and a second position, the movable part being at least a part of the seat, the first operation command may be a command to move the movable part from the first position to the second position, and the controller may move the movable part from the first position to the second position when executing the first control and move the movable part from the second position to the first position when executing the second control.

According to this configuration, since the movable part moves, when the second control is executed, in a direction opposite to a direction in which the movable part moves when the first control is executed, the entertainment value can be increased.

The seat may further increase a third electric device, and the controller may operate the second electric device and the third electric device when the controller executes the second control in response to receiving the first operation command from the first operation unit.

According to this configuration, since the two electric devices other than the first electric device are operated when the second control is executed, the entertainment value can be increased.

The controller may include a switch that switches the mode of the controller between a first mode in which the execution of the second control is disabled, and a second mode in which execution of the second control is enabled.

According to this configuration, the enabling and disabling of the second control can be switched by the intention of the user.

The controller may randomly select the first control and the second control when the controller is in the second mode.

According to this configuration, since the user does not know the timing when the second control is executed, the entertainment value can be increased.

The controller may be configured to execute a third control in which the first electric device is not operated in response to receiving the first operation command from the first operation unit, and the controller may randomly select the first control, the second control, and the third control when the controller is in the second mode.

According to this configuration, since one of the three controls is selected in the second mode, the entertainment value can be increased.

In light of the above-described background, a seat system including the seat and a display is disclosed.

The controller displays a seat image representing the seat and a character image, and moves the character image in correspondence with the second operation state of the first electric device and an operation state of the second electric device, or only moves the character image in correspondence with the second operation state of the first electric device or only moves the character image in correspondence with the operation state of the second electric device, when executing the second control.

According to this configuration, the user can understand through the display that the electric device is not operating as intended by the user because of the character, and the user can thereby be soothed.

The controller may move the character image in correspondence with the first operation state of the first electric device when executing the first control.

According to this configuration, since the character moves as intended by the user, the user can be soothed.

In light of the above-described background, a seat according to another aspect includes an electric device configured to operate when energized, an operation unit that operates the electric device, and a controller that operates the electric device based on an operation command from the operation unit.

The controller selects and executes a first control in which the controller operates the electric device in a first operation state corresponding to the operation command in response to receiving the operation command from the operation unit, and a second control in which the controller operates the electric device in a second operation state that does not correspond to the operation command in response to receiving the operation command from the operation unit.

According to this configuration since the electric device is in an operation state not intended by the user in response to the user operating the operation unit when the controller executes the second control, the entertainment value can be increased.

Further, conventionally, a device known in the art equips a pressure sensor on a seat that is an interior member of a vehicle and estimates the sitting posture of a user (JPH 11-064131A).

The seat in the known art is used only to evaluate the sitting posture of the driver, and lacks entertainment.

It is desirable to increase the entertainment value of the interior member

In light of the above-described background, an interior system including an interior member and a controller is disclosed.

The interior member includes a first portion, second portion that nips an object in combination with the first portion, an electric device that causes at least one of the first portion or the second portion to be pressed against the other one of the first portion or the second portion, and a sensor that detects an object located between the first portion and the second portion.

The controller controls the electric device based on information from the sensor. The controller operates the electric device to cause at least one of the first portion or the second portion to be pressed against the other one of the first portion or the second portion when the controller determines that an object is located between the first portion and the second portion based on information from the sensor in a state where the electric device is not operated.

According to this configuration, since the controller operates the electric device and press the object located between the first portion and the second portion when the object is inserted between the first portion and the second portion, for example, the user can feel that their finger is being nibbled when inserting their finger between the first portion and the second portion, and belongings of the user such as smartphones can be held between the first portion and the second portion. Therefore, the entertainment value can be increased.

The interior system may further include a display configured to display an animal character and the controller may operate the electric device in synchronization with a movement of a mouth of the animal character.

According to this configuration, the user may feel that the character is nibbling their finger when the user inserts their finger between the first portion and the second portion while watching the character displayed on the display.

The sensor may be a pressure sensor that detects the pressure between the first portion and the second portion, and the controller may set an operation pattern of the electric device based on the magnitude of the pressure acquired from the pressure sensor.

According to this configuration, since the operation pattern of the electric device is set by the magnitude of the pressure when the pressure changes by the movement of the finger between the first portion and the second portion, the entertainment value can be increased.

The sensor may be a biometric information detecting sensor that detects biometric information and the controller may set the operation pattern of the electric device based on the biometric information acquired from the biometric information detecting sensor.

According to this configuration, since the operation pattern of the electric device is set based on biometric information such as pulse rate and body temperature, the entertainment value can be increased.

In light of the above-described background, in one aspect, a seat includes a pad and an outer covering with which the pad is covered.

The pad includes a first portion, a second portion adjacent to the first portion and a groove formed between the first portion and the second portion into which the outer covering is tucked.

The seat further includes an electric device that causes at least one of the first portion or the second portion to be pressed against the other one of the first portion or the second portion.

According to this configuration, since the user can feel that something nibbled their finger when the electric device is operated in response to the user inserting their finger in the tuck-in groove, the entertainment value of the seat as an interior member can be increased.

In light of the above-described background a seat according to another aspect includes a seat cushion and a seat back.

The seat cushion includes a first portion.

The seat back includes a second portion opposed to the first portion.

The seat further includes an electric device configured to cause at least one of the first portion or the second portion to be pressed against the other one of the first portion or the second portion.

According to this configuration, since the user can feel that something nibbled their finger when the electric device is operated in response to the user inserting their finger between the first portion of the seat cushion and the second portion of the seat back, the entertainment value of the seat as an interior member can be increased.

In light of the above-described background a seat according to another aspect includes a headrest and a seat back.

The headrest includes a first portion.

The seat back includes a second portion opposed to the first portion.

The seat further includes an electric device configured to cause at least one of the first portion or the second portion to be pressed against the other one of the first portion or the second portion.

According to this configuration, since the user can feel that something nibbled their finger when the electric device is operated in response to the user inserting their finger between the first portion of the headrest and the second portion of the seat back, the entertainment value of the seat as an interior member can be increased.

In light of the above-described background a vehicle interior member comprising a first portion, a second portion that nips an object in combination with the first portion, and an electric device configured to cause at least one of the first portion or the second portion to be pressed against the other one of the first portion or the second portion is disclosed.

According to this configuration, since the user can feel that something nibbled their finger when the electric device is operated in response to the user inserting their finger in the tuck-in groove, the entertainment value of the seat as an interior member can be increased.

At least one of the first portion or the second portion may include a sensor that detects an object located between the first portion and the second portion when the electric device is not in the operation state.

According to this configuration, since the electric device can be caused to be operated in condition that the sensor detects the object, the electric device can be operated and stopped based on the inserting into and pulling out of the object from between the first portion and the second portion.

The sensor may be a pressure sensor that detects the pressure between the first portion and the second portion.

The sensor may be a capacitive sensor that detects objects based on change in the capacitance when an object enters the electric field.

The sensor may be a resistive touch sensor.

At least one of the first portion or the second portion may include a sensor.

According to this configuration, since the heater may be set at a temperature equivalent to a body temperature of an animal, the user may feel that an animal is nibbling their finger.

The vehicle interior member may include a unit including the first portion, the second portion, and the electric device, and a base portion to which the unit is attachable to and removable from.

According to this configuration, the unit for holding an object can be replaced easily.

### BRIEF DESCRIPTION OF DRAWINGS

FIG. 1 is an illustration of a seat system according to a first embodiment.

FIGS. 2 (a) and (b) are cross-sectional views showing operation of the air cell disposed in the seat cushion.

FIG. 3 is a block diagram showing the relationship between the components such as the controller and the electric device.

FIG. 4 is a flowchart showing an operation of the controller.

FIG. 5 is an illustration showing a home screen of a cat mode.

FIG. 6 (a) is an illustration showing a cat tilting a seat back rearward, and (b) is an illustration showing a movement of the seat in accordance with the image.

FIG. 7 (a) is an illustration showing a cat sliding the seat rearward, and (b) is an illustration showing a movement of the seat in accordance with the image.

FIG. 8 (a) is an illustration showing a cat sneaking under the seat, and (b) is an illustration showing a movement of the seat in accordance with the image.

FIG. 9 (a) is an illustration showing a cat relaxing on the seat, and (b) is an illustration showing a movement of the seat in accordance with the image.

FIG. 10 (a) is an illustration showing a cat sharpening its claws on the seat, and (b) is an illustration showing a movement of the seat in accordance with the image.

FIG. 11 (a) is an illustration of a cat going out for a walk, and (b) is an illustration showing a movement of the seat in accordance with the image.

FIG. 12 is an illustration of a vehicle comprising a seat system according to a second embodiment.

FIG. 13 is a flow chart showing an operation of the controller according to the second embodiment.

FIGS. 14 (a) and (b) are illustrations showing an example of an image-seat linking process for a seat system comprising a plurality of seats.

FIG. 15 is an illustration showing a modified example of the seat system.

FIG. 16 is an illustration of a seat system according to a third embodiment. FIGS. 17 (a) and (b) are cross-sectional views showing operation of the air cell disposed in the seat cushion.

FIG. 18 is a block diagram showing the relationship between the components such as the controller and the air cell.

FIG. 19 is a flow chart showing the operation of the controller.

FIG. 20 is an illustration showing a home screen of a nibbling mode.

FIG. 21 is an illustration of an animation of a dog on the screen nibbling on a finger.

FIG. 22 is an illustration showing a modified example in which a position of a unit for nipping an object is modified.

FIG. 23 is an illustration showing a state in which an image of a dog is projected on a rear surface of the seat.

FIG. 24 is an illustration of examples of positions in which the unit for nipping the object is disposed.

FIG. 25 is a cross-sectional view of an embodiment in which the first portion and the second portion comprises plate members.

FIG. 26 is an illustration showing a modified example in which a position of a unit for nipping an object is modified.

FIG. 27 (a) is cross-sectional view of an embodiment in which the second portion comprises a plurality of sensors, and (b) is a cross-sectional view taken along line X-X of FIG. 26.

FIG. 28 is an illustration showing an embodiment in which the unit for nipping an object is attachable to and removable from the seat.

### DESCRIPTION OF EMBODIMENTS

### First Embodiment

A first embodiment of a seat system will be described below with reference made to the attached drawings.

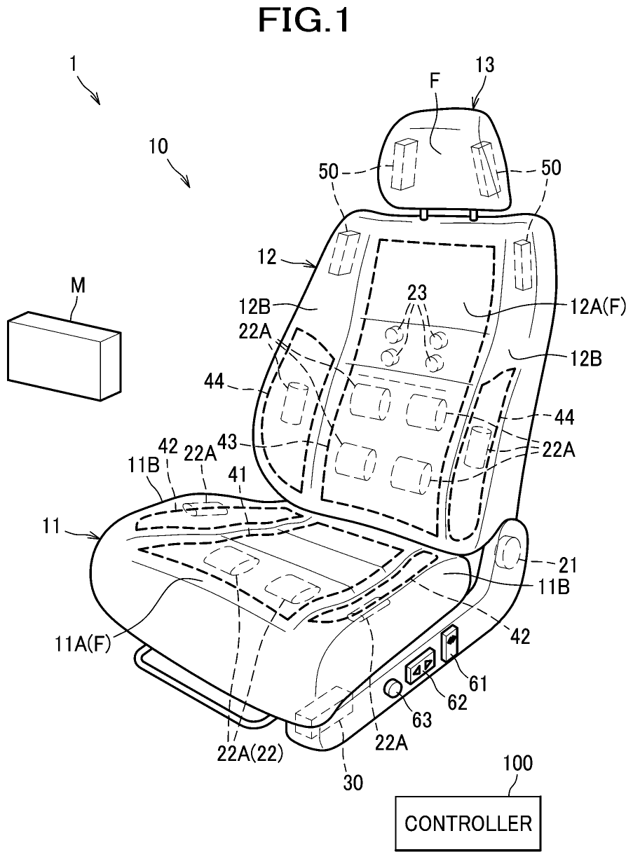

As shown in FIG. 1, a seat system 1 comprises a seat 10 on which the user can be seated, a monitor M as an example of a display, and a controller 100. The seat 10 comprises a seat cushion 11, a seat back 12, and a headrest 13. The seat cushion 11, the seat back 12, and the headrest 13 constitutes a seat body comprising a seating surface F contactable with the user.

The seat cushion 11 comprises a base portion 11A located in a laterally central portion of the seat cushion 11 and projecting portions 11B disposed laterally outward of the base portion 11A. The base portion 11A contacts and supports the buttocks and the thighs of the user from below. The projecting portions 11B project from the base portion 11A toward the user to support the sides of the thighs and the buttocks of the user.

The seat back 12 similarly comprises a base portion 12A located in a laterally central portion of the seat back 12 and projecting portions 12B disposed laterally outward of the base portion 12A. The base portion 12A contacts and supports the back of the user from behind. The projecting portions 12B project toward the user to support the sides of the upper body of the user.

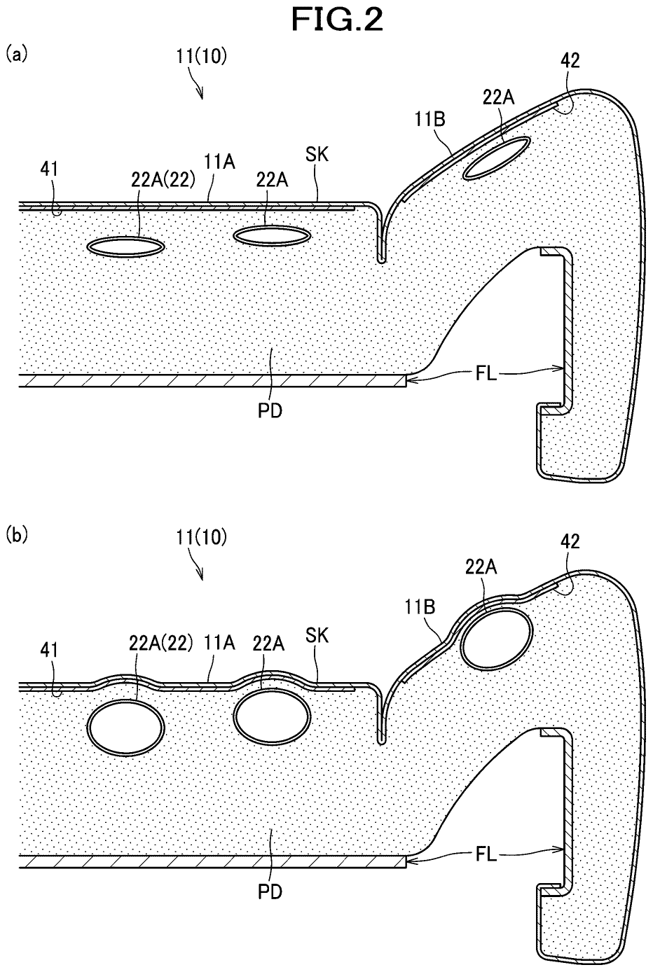

As shown in FIG. 2, the seat cushion 11 comprises a frame FL, a pad PD, and a covering SK. The frame FL is, for example, made of metal and supports the pad PD. The pad PD is made of cushioning material such as urethane foam. The outer covering SK is made of synthetic leather, fabric, or the like, and covers the pad PD. The seat back 12 and the headrest 13 similarly comprises a frame, a pad, and an outer covering.

Referring back to FIG. 1, the seat 10 further comprises an electric reclining mechanism 21, a plurality of air cells 22, a plurality of vibrating devices 23, an electric sliding mechanism 30, a plurality of heaters 41 to 44, and a plurality of speakers 50. The electric reclining mechanism 21, the air cells 22, the vibrating devices 23, the electric sliding mechanism 30, the heaters 41 to 44, and the plurality of speakers 50 are electric devices configured to operate when energized. Among the electric devices, the electric reclining mechanism 21, the air cells 22, and the vibrating devices 23 are electric devices that move only a portion of the seat 10. In other words, the electric reclining mechanism 21, the air cells 22, and the vibrating devices 23 partially move a portion of the seat 10.

The electric reclining mechanism 21 is a mechanism that tilts the seat back 12. The electric reclining mechanism 21 comprises a motor that operates when energized.

Each air cell 22 comprises a bag 22A that can be inflated and deflated, and an air pump and a tube not shown in the drawings. The air pump has a function of pumping air into the bag 22A and sucking out air from the bag 22A, and operates when energized. The tube connects the bag 22A and the air pump.

As shown in FIG. 2, the bag 22A is embedded within the pad. The air pump is, for example, fixed to the frame of the seat 10. The bag 22A moves a portion of the seating surface F of the seat 10 between a first position shown in FIG. 2(a) and a second position shown in FIG. 2(b). Here, the second position is a position protruding further toward the user than the first position.

Referring back to FIG. 1, the seat cushion 11 comprises a plurality of the bags 22A. A plurality of the bags 22A, for example, two bags 22A, are disposed in the base portion 11A of the seat cushion 11. One bag 22A is disposed in each of the projecting portions 11B on the left side and the right side of the seat cushion 11.

The seat back 12 comprises a plurality of the bags 22A. A plurality of the bags 22A, for example, four bags 22A, are disposed in the base portion 12A of the seat back 12. One bag 22A is disposed in each of the projecting portions 12B on the left side and the right side of the seat back 12.

The vibrating devices 23 are devices that vibrate when energized. A plurality of the vibrating devices 23, for example, four vibrating devices 23, are provided in the base portion 12A of the seat back 12. The vibrating devices 23 are, for example, embedded within the pad.

The electric sliding mechanism 30 is a mechanism that causes the seat 10 to slide in the front-rear direction. Here, the seat 10 is supported by slide rails not shown in the drawings in a manner that allows the seat 10 to move in the front-rear direction. The electric sliding mechanism 30 comprises a motor that is operated when energized.

The heaters 41 to 44 are planar heating elements that generate heat when energized. The heaters 41 to 44 are disposed between the outer covering and the pad (see FIG. 2). The heater 41 is provided at the base portion 11A of the seat cushion 11. One heater 42 is provided at each of the projecting portions 11B on the left side and the right side of the seat cushion 11.

The heater 43 is provided at the base portion 12A of the seat back 12. One heater 44 is provided at each of the projecting portions 12B on the left side and the right side of the seat back 12.

The speakers 50 are devices that generate sounds when energized. One speaker 50 is provided at the left upper portion of the seat back 12 and one speaker 50 is provided at the right upper portion of the seat back 12. One speaker 50 is provided at the left side of the headrest 13 and one speaker 50 is provided at the right side of the headrest 13. The speakers 50 are, for example, embedded in the pad.

The seat 10 further comprises a reclining switch 61, a sliding switch 62, and a mode selecting switch 63.

The reclining switch 61 is an operation unit for operating the electric reclining mechanism 21. The reclining switch 61 is, for example, tiltable in the front-rear direction. The reclining switch 61 outputs to the controller 100 a forward-tilt command when the reclining switch 61 is tilted forward to cause the seat back 12 to tilt forward. The reclining switch 61 outputs to the controller 100 a rearward-tilt command when the reclining switch 61 is tilted rearward to cause the seat back 12 to tilt rearward.

The sliding switch 62 is an operation unit for operating the electric sliding mechanism 30. The sliding switch 62, is for example, slidable in the front-rear direction. The sliding switch 62 outputs to the controller 100 a forward-slide command when the sliding switch 62 is slid forward to move the seat 10 forward. The sliding switch 62 outputs to the controller 100 a rearward-slide command when the sliding switch 62 is slid rearward to move the seat 10 rearward.

The mode selecting switch 63 is a switch for switching the mode of the controller 100 to a first mode and to a second mode. Here, the first mode is a mode in which execution of a second control described below is disabled. The second mode is a mode in which execution of the second control is enabled. The mode selecting switch 63 is, for example, a push-button switch. Each time the mode selecting switch 63 is pushed by the user, the mode selecting switch 63 alternately switches between an ON state and an OFF state.

The controller 100 comprises components such as a Central Processing Unit (CPU), a Read Only Memory (ROM), a Random Access Memory (RAM), and the like. The controller 100 may be provided at the seat 10, or at a member other than the seat 10.

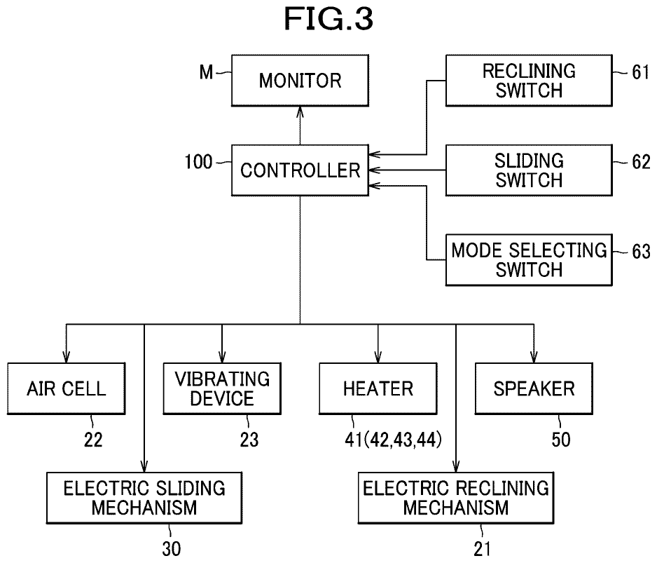

As shown in FIG. 3, the controller 100 is connected to the monitor M, each of the switches (61 to 63), and each of the electric devices (21 to 23, 30, 41 to 44, and 50). The controller 100 is capable of individually operating each of the plurality of heaters 41 to 44, and individually operating each of the plurality of air cells 22, the plurality of vibrating devices 23, and the plurality of speakers 50. The controller 100 has a function of selecting and executing a first control, a second control, and a third control.

The first control is a control in which the controller operates one of the electric devices in a first operation state corresponding to an operation command in response to receiving the operation command from the operation unit. In other words, the first control is a control in which the controller operates the electric device in an operation state as intended by the user.

In more detail, when the controller 100 executes the first control based on a command from the reclining switch 61, the controller 100 operates the electric reclining mechanism 21 so that the seat back 12 is caused to tilt forward if the command is the forward-tilt command, and operates the electric reclining mechanism 21 so that the seat back 12 is caused to tilt rearward if the command is the rearward-tilt command. Further, when the controller 100 executes the first control based on a command from the sliding switch 62, the controller 100 operates the electric sliding mechanism 30 so that the seat 10 is caused to slide forward if the command is the forward-slide command, and operates the electric sliding mechanism 30 so that the seat 10 is caused to slide rearward if the command is the rearward-slide command.

The second control is a control in which the controller operates the electric device in a second operation state that does not correspond to the operation command in response to receiving the operation command from the operation unit. In other words, the second control is a control in which the controller operates the electric device in an operation state contrary to the intention of the user.

In more detail, when the controller 100 executes the second control based on a command from the reclining switch 61, the controller 100 operates the electric reclining mechanism 21 so that the seat back 12 is caused to tilt rearward if the command is the forward-tilt command, and operates the electric relining mechanism 21 so that the seat back 12 is caused to tilt forward if the command is the rearward-tilt command. Further, when the controller 100 executes the second control based on a command from the sliding switch 62, the controller 100 operates the electric sliding mechanism 30 so that the seat 10 is caused to slide rearward if the command is the forward-slide command, and operates the electric sliding mechanism 30 so that the seat 10 is caused to slide forward if the command is the rearward-slide command. In other words, during the second control, the controller 100 controls the electric device to perform an operation opposite to the operation command.

Here, the seat back 12 and the seat 10 correspond to a movable part that is at least a part of the seat. The electric reclining mechanism 21 and the electric sliding mechanism 30 correspond to a mechanism configured to move the movable part between a first position and a second position. Further, for example, the forward-tilt command and the forward-slide command correspond to a command to move the movable part from the first position to the second position. The controller 100 moves the movable part from the first position toward the second position when executing the first control, and moves the movable part from the second position toward the first position when executing the second control.

The third control is a control in which the controller does not operate the electric device in response to receiving the operation command from the operation unit. In other words, the third control is a control in which the controller does not operate the electric device contrary to the intention of the user.

In more detail, when the controller 100 executes the third control, the electric reclining mechanism 21 is not operated in response to receiving a command from the reclining switch 61. Further, when the controller 100 executes the third control, the electric sliding mechanism 30 is not operated in response to receiving a command from the sliding switch 62.

The controller 100 is switchable to a first mode and to a second mode by operating the mode selecting switch 63. The first mode is a mode in which the electric device is caused to operate in a state intended by the user. In the following description, the first mode is also referred to as “normal mode”.

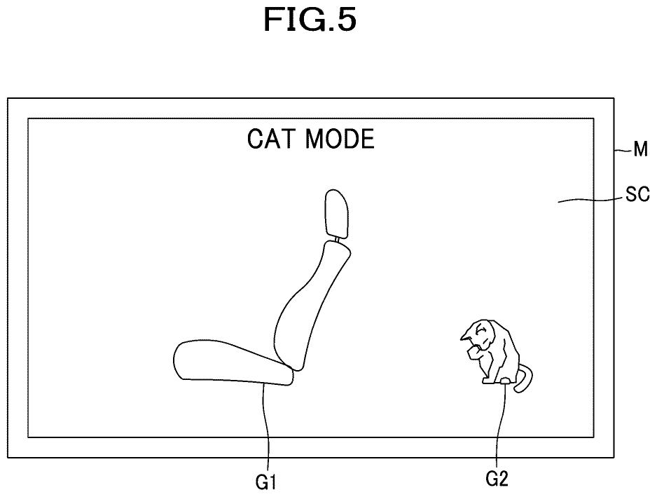

The second mode is a mode that enables interaction with a cat displayed on a screen SC of the monitor M shown in FIG. 5 via the seat 10. In the following descriptions, the second mode is also referred to as “cat mode”.

In the cat mode, the controller 100 controls each of the electric devices in response to the action the cat displayed on the screen SC of the monitor M performs on the seat. In the cat mode, the electric device operates as intended by the user, operates contrary to the intention of the user, or does not operate contrary to the intention of the user.

The controller 100 is in the normal mode when the mode selecting switch 63 is in the OFF state. The controller 100 is in the cat mode when the mode selecting switch 63 is in the ON state.

In the normal mode, the controller 100 only executes the first control when the operation command is inputted. In the cat mode, the controller selects and executes a first control, a second control, and a third control when the operation command is inputted. The probability of each control being selected may be the same or may be different. For, example, the probability of the first control being selected may be set higher than the probabilities of the second control and the third control being selected.

In the cat mode, the controller 100 displays on the screen SC of the monitor M a seat image G1 representing the seat 10 and a character image G2 representing a cat. In the cat mode, the controller 100 executes an image-seat linking process in which an animation of the character image G2 performing an action on the seat image G2 is played on the screen SC, and at least a part of the seat 10 is moved by the electric device in synchronization with the action of the character image G2. Here, the timing for starting to play the animation and the timing for starting the operation of the electric device may be simultaneous, or either may be first.

In the cat mode, in response to receiving the operation command for operating the electric device, the controller 100 selects the first control, the second control, or the third control and executes the image-seat linking process. In more detail, the controller 100 causes the character image G2 to move in accordance with the state of the electric device corresponding to the selected control.

In the cat mode, the controller 100 also executes the image-seat linking process when the operation command for operating the electric device is not received and a condition other than the operation command is satisfied. In the present embodiment, the other condition is defined as “an operation command not being input for a predetermined period of time”. In the image-seat linking process executed when an operation command is not input, the controller 100 randomly selects the animation (image) to be played on the screen SC and operates the corresponding electric device in accordance with the selected animation. Further, the controller 100 may randomly select the electric device to be operated and play on the screen SC the animation corresponding to the movement of the selected electric device.

Specific examples of the image-seat linking process will be described below.

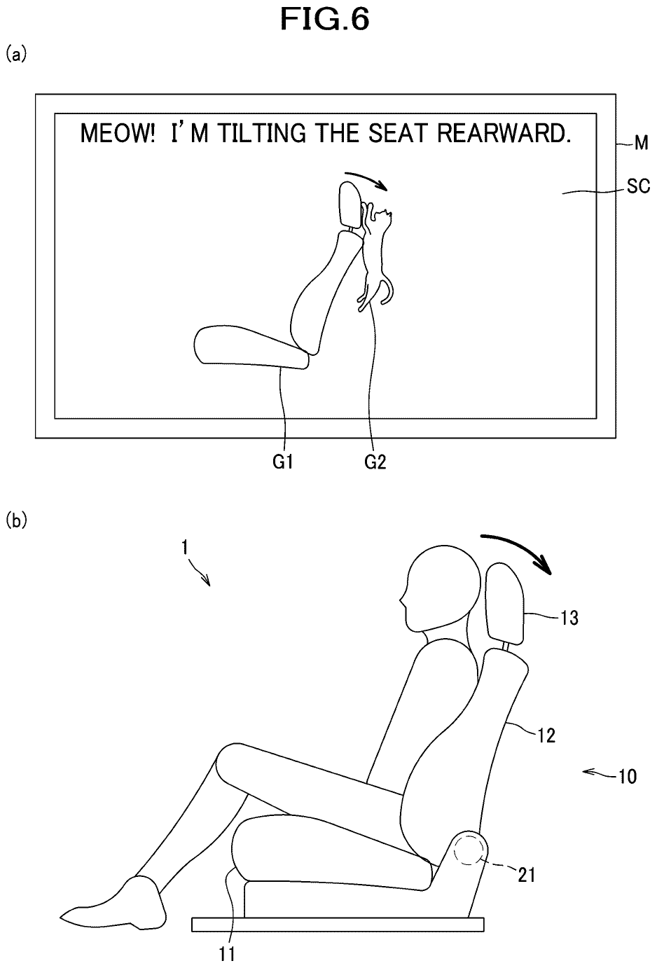

As shown in FIGS. 6 (a) and (b), when tilting the seat back 12 rearward, the controller 100 plays on the screen SC an animation in which the character image G2 performs an action on a portion of the seat image G1 corresponding to the seat back 12, and causes the reclining mechanism 21 to tilt the seat back 12 rearward in synchronization with the action of the character image G2. In the present embodiment, the controller 100 plays on the screen SC an animation in which a cat holding on to and dangling from a vicinity of a portion of the seat image G1 corresponding to the seat back, and the portion of the seat image G1 corresponding to the seat back is gradually tilted rearward. Further, the controller 100 displays on the screen SC a text image such as “Meow! I'm tilting seat rearward.”, which indicates the action of the cat.

The controller 100 may output the contents of the text image as an audio message through the speaker 50. In this case, the audio message may be output from the speaker 50 closest to the position of the mouth of the cat on the screen SC, for example, the speaker 50 of the headrest 13.

The controller 100 causes the electric reclining mechanism 21 to tilt the actual seat back 12 rearward in synchronization with the character image G2 tilting the seat back portion of the seat image G2 rearward. In other words, the controller 100 operates the electric reclining mechanism 21 and causes the actual seat back 12 to gradually tilt rearward in synchronization with the movement of the seat back portion of the seat image G1 titling rearward by the cat holding on to and dangling from the seat back portion.

When tilting the seat back 12 forward, for example, an animation of the cat pushing the seat back portion forward may be played on the screen SC, or an animation of the cat pulling an upper portion of the seat back portion from the front using a rope or the like may be played on the screen SC. Also, when tilting the seat back 12 forward, the controller 100 causes the actual seat back 12 to gradually tilt forward in synchronization with the movement of the cat and the seat back portion displayed on the screen SC.

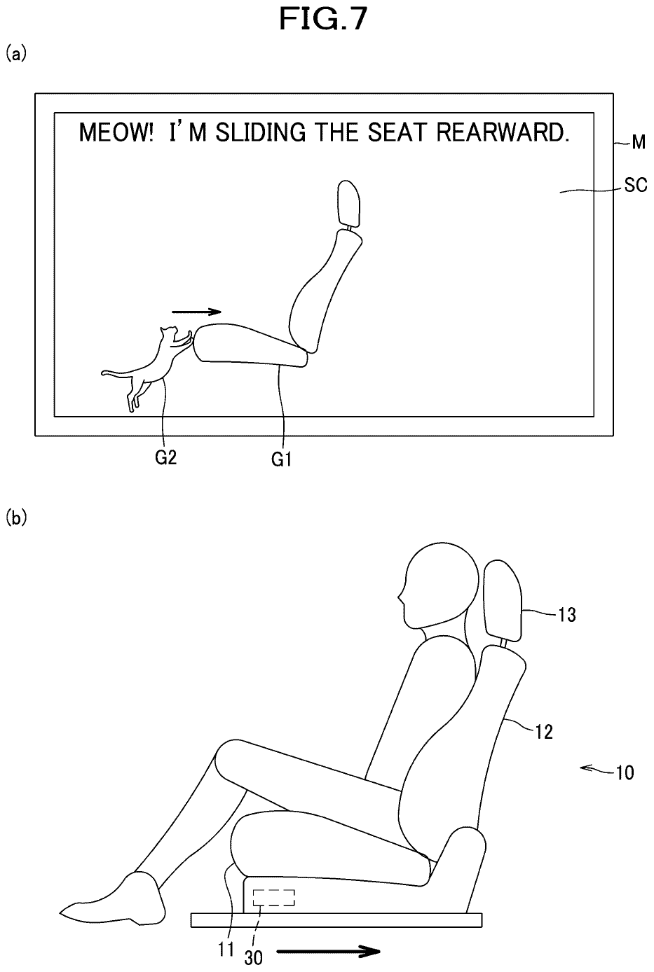

As shown in FIGS. 7 (a) and (b), when sliding the seat 10 rearward, the controller 100 plays an animation of the cat and the seat moving rearward by the cat pushing the seat from the front, and causes the electric sliding mechanism 30 to move the seat 10 rearward in synchronization with the movement of the cat and the seat on the screen SC. Further, the controller 100 displays on the screen SC a text image such as “Meow! I'm sliding the seat rearward.”, which indicates the action of the cat. In this case, the contents of the text image may also be output as an audio message by the speaker 50 in a manner similar to that described above.

When sliding the seat 10 forward, for example, an animation of the cat pushing the seat forward may be played on the screen SC, or an animation of the cat pulling the seat from the front using a rope or the like may be displayed on the screen SC. Also, when sliding the seat 10 forward, the controller 100 causes the actual seat 10 to gradually move forward in synchronization with the movement of the cat and the seat on the screen SC.

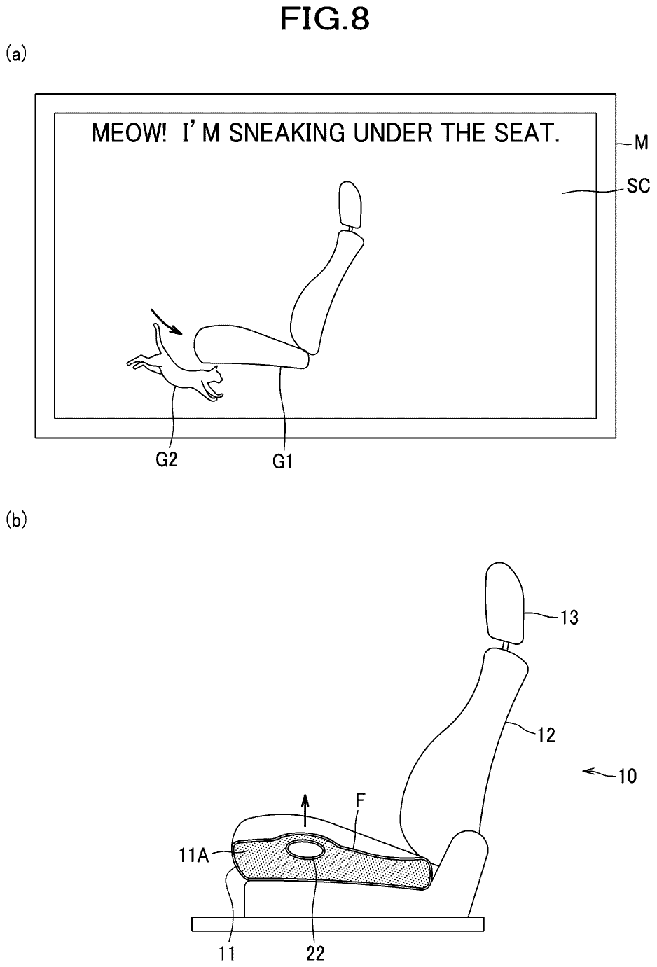

As shown in FIGS. 8 (a) and (b), when playing on the screen SC an animation of the cat sneaking under the seat cushion, the controller 100 moves a part of the seating surface F of the base portion 11A by operating the air cell 22 disposed in the base portion 11A of the cushion 11 in synchronization with the character image G2 pushing up the seat cushion portion of the seat image G1. The air cell 22 that is operated may be at least the air cell 22 on the right side or the air cell 22 on the left side. Further, the controller 100 displays on the screen SC a text image such as “Meow! I'm sneaking under the seat.”, which indicates the action of the cat. In this case, the contents of the text image may also be output as an audio message through the speaker 50 in a manner similar to that described above.

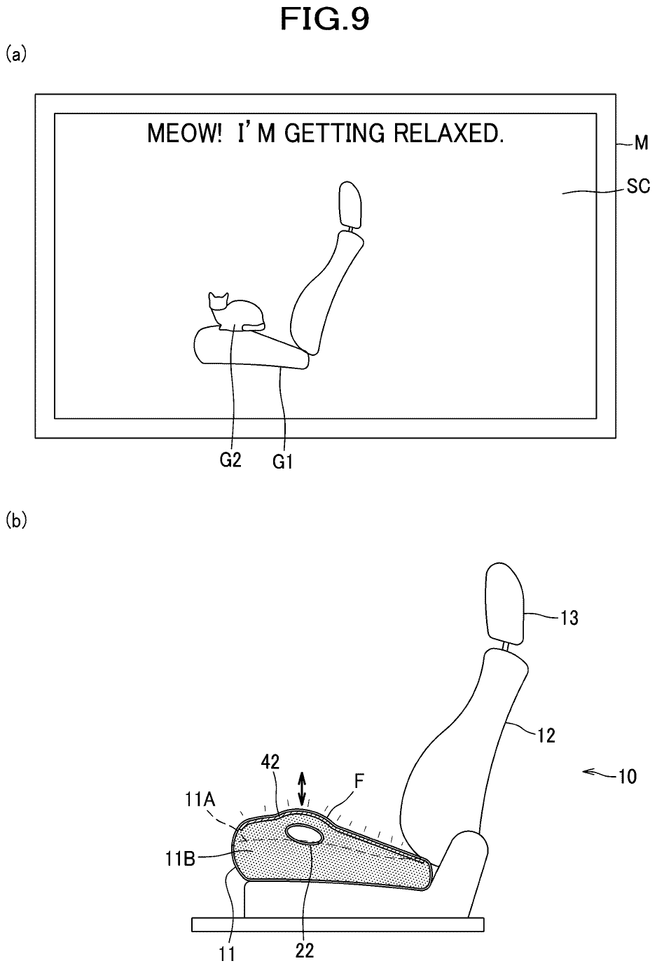

As shown in FIGS. 9 (a) and (b), when playing on the screen SC an animation of the cat relaxing on the projecting portion of the seat cushion, the controller 100 causes the air cells 22 disposed on the projecting portions 11B of the seat cushion 11 to expand and contract in synchronization with the character image G2 repeatedly moving a portion of the projecting portion of the seat image G1 as a result of the body of the character image G2 expanding and contracting in accordance with the breathing of the character image G2. As a result, the air cell 22 moves a portion of the seating surface F of the projecting portion 11B of the seat cushion 11 back and forth between a first position and a second position.

Further, when playing on the screen SC the animation of the cat relaxing on the projecting portion of the seat cushion, the controller 100 operates the heater 42 disposed in the projecting portion 11B. In other words, the controller 100 displays the character image G2 in a position of the seat image G1 corresponding to the heater 42 and the air cell 22, and operates the heater 42 and the air cell 22. Further, the temperature of the heater 42 is preferably set at a temperature equivalent to a body temperature of a cat.

Further, the controller 100 displays on the screen SC a text image such as “Meow! I'm getting relaxed.”, which indicates the state of the cat. In this case, the contents of the text image may also be output as an audio message through the speaker 50 in a manner similar to that described above.

Since the projecting portions 11B are disposed on the left and right sides of the actual seat 10, if the seat displayed on the screen SC is an image as viewed from the side, it would be sufficient if the air cell 22 and the heater 42 provided in at least one of the two projecting portions 11B are operated. If the seat displayed on the screen is a 3D image viewed from an angle, or an image as viewed from the front, it would be sufficient if the air cell 22 and the heater 42 of the projecting portion 11B on which the cat is located, of the projecting portions 11B on the left side and the right side, are operated.

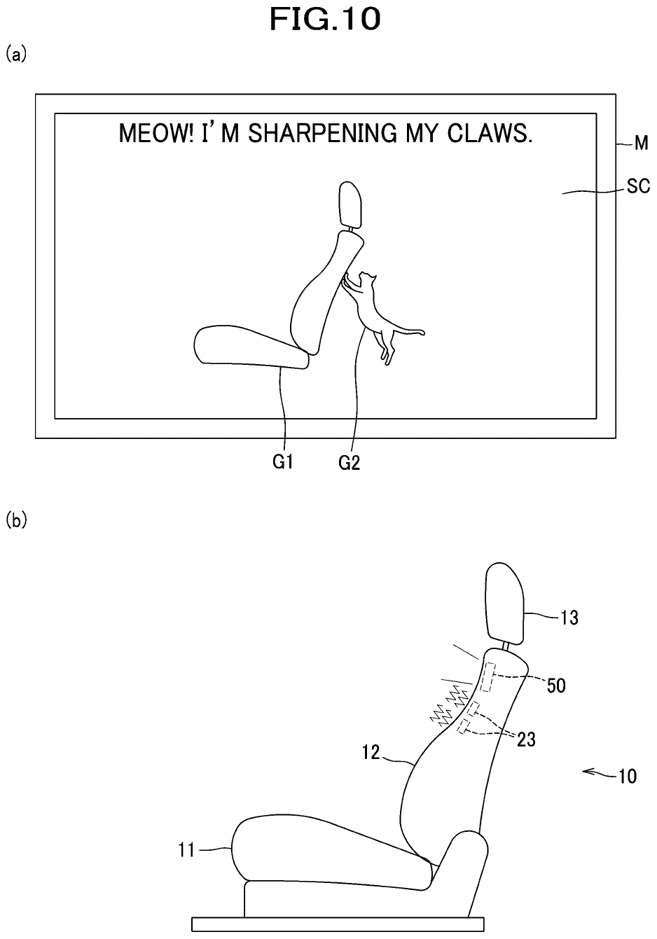

As shown in FIGS. 10 (a) and (b), when displaying on the screen SC an animation of the cat sharpening its claws on the seat back, the controller 100 operates the vibrating device 23 and the speaker 50 in the seat back 12 in synchronization with the movement of the front paws of the cat sharpening its claws. In more detail, when the cat on the screen SC is scratching the seat back with its left front paw, the controller 100 causes the vibrating device 23 on the left side of to vibrate, and outputs a sound of the seat being scratched from the speaker 50 on the left side. Further, when the cat on the screen SC is scratching the seat back with its right front paw, the controller 100 causes the vibrating device 23 on the right side to vibrate, and outputs a sound of the seat being scratched through the speaker 50 on the right side.

Since there are two vibrating devices 23 on the left side and two vibrating devices 23 on the right side, it is sufficient if the controller 100 vibrate at least one of the vibrating devices 23 on the left side and at least one of the vibrating devices 23 on the right side.

When displaying on the screen SC an animation of the cat going out for a walk, the controller 100 moves the character image G2 away from the seat image G1 and does not operate the electric device for moving a part of the seat 10. Further, the controller 100 displays on the screen SC a text image such as “Meow! I'm heading out for a walk.”, which indicates the action of the cat. In this case, the contents of the text image may also be output as an audio message through the speaker 50 in a manner similar to that described above.

Next, operation of the controller 100 will be described in detail.

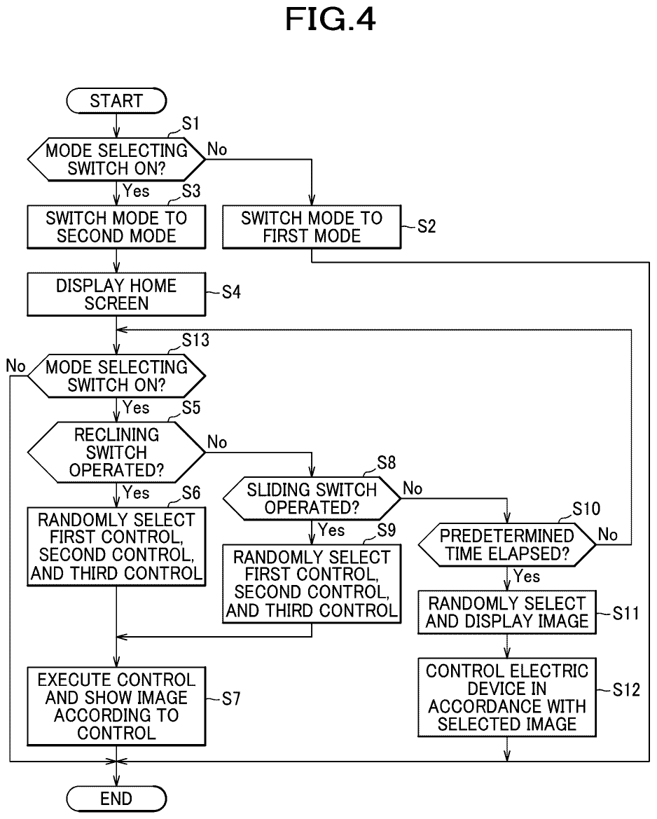

The controller 100 repeatedly executes the process shown in FIG. 4. In the process shown in FIG. 4, the controller 100 first determines whether the mode selecting switch 63 is ON (S1). If it is determined in step S1 that the mode selecting switch 63 is not ON (No), the controller 100 sets the mode to the first mode, i.e., the normal mode (S2), and ends the process. The controller 100 executes only the first control if the operation command is input in the normal mode.

If it is determined in step S1 that the mode selecting switch 63 is ON (Yes), the controller 100 sets the mode to the second mode, i.e., the cat mode (S3), and displays on the screen SC a home screen shown in FIG. 5 (S4). After step S4, the controller 100 determines whether the mode selecting switch 63 is ON (S13).

If it is determined in step S13 that the mode selecting switch 63 is ON (Yes), the controller determines whether the reclining switch 61 has been operated (S5). If it is determined in step S13 that the mode selecting switch 63 is not ON (No), the controller 100 ends the process.

If it is determined in step S5 that the reclining switch 61 has been operated (Yes), the controller 100 randomly selects one of the first control, the second control, or the third control corresponding to the operation command from the reclining switch 61 (S6). After step S6, the controller 100 executes the selected control and displays on the screen SC an image matching the control that is executed (S7), and ends the process.

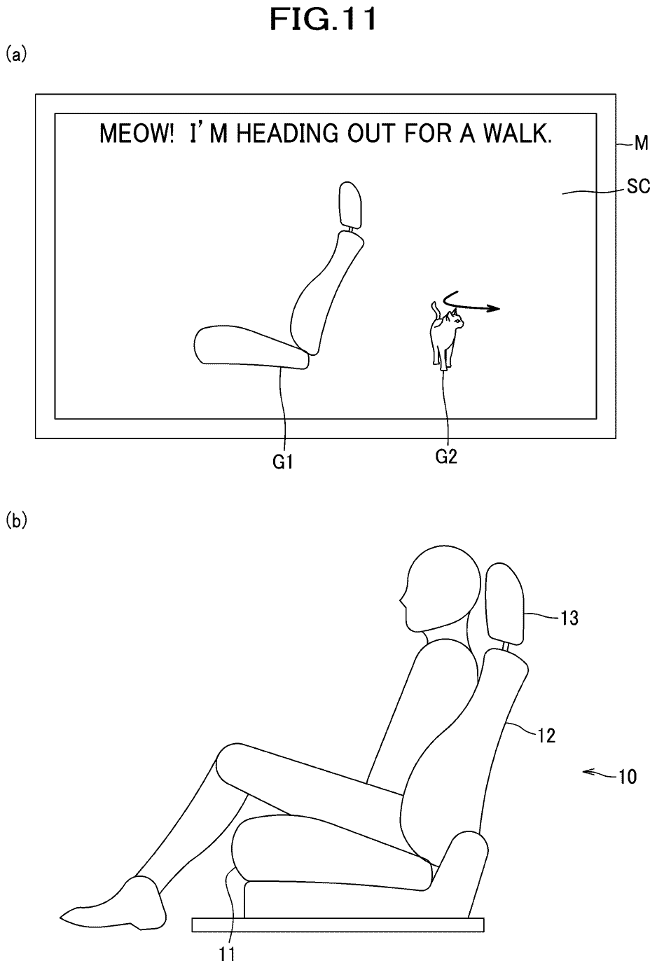

In more detail, for example, if the operation command from the reclining switch 61 is the rearward-tilt command and the first control is selected, the controller 100 plays on the screen SC the animation shown in FIG. 6 (a), and causes the seat back 12 to tilt rearward by the electric reclining mechanism 21. Further, for example, if the operation command from the reclining switch 61 is the forward-tilt command and the second control is selected, the controller 100 plays on the screen SC the animation shown in FIG. 6 (a), and causes the seat back 12 to tilt rearward by the electric reclining mechanism 21. Additionally, for example, if the third control is selected, the controller 100 plays on the screen SC the animation shown in FIG. 11 (a) and does not operate the electric reclining mechanism 21.

If it is determined No in step S5, the controller 100 determines whether the sliding switch 62 has been operated (S8). If it is determined in step S8 that the sliding switch 62 has been operated (Yes), the controller 100 randomly selects one of the first control, the second control, the third control corresponding to the operation command from the sliding switch 62 (S9). After step S9, the controller 100 executes the selected control and displays on the screen SC an image matching the control that is executed (S7), and ends the process.

In more detail, for example, if the operation command from the sliding switch 62 is the rearward-slide command and the first control is selected, the controller 100 plays on the screen SC the animation shown in FIG. 7 (a), and causes the seat 10 to slide rearward by the electric sliding mechanism 30. Further, for example, if the operation command from the sliding switch 62 is the forward-slide command and the second control is selected, the controller 100 plays on the screen SC the animation shown in FIG. 7 (a), and causes the seat 10 to slide rearward by the electric sliding mechanism 30. Additionally, for example, if the third control is selected, the controller 100 plays on the screen SC the animation shown in FIG. 11 (a) and does not operate the electric sliding mechanism 30.

If it is determined No in step S8, the controller 100 determines whether a predetermined period of time has elapsed since the start of the second mode or since the last time one of the operation units (61, 62) has been operated (S10). If it is determined in step S10 that a predetermined period of time has not elapsed (No), the controller 100 returns to the process of step S5.

If it is determined in step S10 that the predetermined period of time has elapsed (Yes), the controller 100 randomly selects an image from the images shown in FIGS. 6 to 11 and displays it on the screen SC (S11). After step S11, the controller 100 controls the electric device in accordance with the selected image (S12) and ends the process.

Next, a specific example of an operation of the controller 100 will be described.

As shown in FIG. 1, in the normal mode, when a user seated on the seat 10 tilts the reclining switch 61 rearward, the controller 100 executes the first control, which causes the seat back 12 to be tilted rearward as intended by the user. When the user slides the sliding switch 62 rearward, the controller 100 executes the first control, which causes the seat 10 to slide rearward as intended by the user.

When the user pushes and switches the mode selecting switch 63 ON, the mode of the controller 100 is switched to the cat mode. In the cat mode, the controller 100 first displays on the screen SC the home screen shown in FIG. 5 (a). In the cat mode, if the controller 100 selects the first control when the user tilts the reclining switch 61 rearward and the rearward-tilt command is output from the reclining switch 61, the controller 100 displays on the screen SC the image shown in FIG. 6 (a) and causes the seat back 12 to tilt rearward as intended by the user. At this time, the user can recognize that the cat is assisting the user's operation by looking at the screen SC, which will foster affection for the cat.

In the cat mode, if the controller 100 selects the second control when the user tilts the reclining switch 61 forward and the forward-tilt command is output from the reclining switch 61, the controller 100 displays on the screen SC the image shown in FIG. 6 (a) and causes the seat back 12 to tilt rearward contrary to the intention of the user. At this time, the user will be surprised that an operation opposite to the operation conducted by the user is performed. However, since the action of the cat tilting the seat back rearward is displayed on the screen SC, the user recognizes it is the cats doing, and is soothed by the self-centered nature of the disobedient cat.

In the cat mode, if the controller 100 selects the third control when the user operates the reclining switch 61, the controller 100 displays on the screen SC the image shown in FIG. 11 (a) and does not move the seat back 12. At this time, the user will be surprised that the seat back 12 does not move even though the reclining switch 62 has been operated. However, since the cat heading out for a walk is displayed on the screen SC, the user is soothed by the whimsical behavior of the cat.

In the cat mode, when the user does not operate the operation unit for a predetermined period of time, the controller 100 randomly selects an image to be displayed from the images shown in FIGS. 6 to 11, and controls the electric device in accordance with the selected image. If the images of FIGS. 6, 7, or 10 is selected, the user will be surprised by the entire seat 10 or the seat back 12 moving on its own or the sudden occurrence of vibrations and scratching noises. However, since the user can understand that these are due to the mischief of a cat by looking at the screen SC, the user is soothed by the mischievous nature of the cat.

When the image of FIG. 8 or FIG. 9 is selected, the user can feel the presence of the cat via the seat 10, for example, by the movement of the air cells 22, which will foster affection for the cat.

The controller 100 returns the display on the screen SC to the home screen (S1: Yes→S3→S4) after executing the first control, the second control, or the third control. If the user switches the mode selecting switch 63 OFF to end the cat mode when the home screen is displayed on the screen SC, the controller 100 sets the mode to the normal mode (S13: No→S1; No→S2). When the mode selecting switch 63 is switched from ON to OFF, the controller 100 stops displaying the images of the cat mode on the screen SC.

The following advantageous effects can be achieved by the present embodiment.

When the character image G2 on the screen SC performs an action on a portion of the seat image G, a corresponding portion of the actual seat 10 is moved by the electric device 1; therefore, it is easier for the user to feel the presence of the cat. In more detail, for example, the electric device pushes a corresponding portion of the actual seat 10 when the cat pushes a portion of the seat, which enables the user to feel as if the cat is pushing the user via the seat 10. Thus, the user can interact with the cat via the seat 10.

By using an image resembling a cat as the character image G2, the user can interact with the cat via the seat 10; therefore, a soothing effect is achieved. By moving a part of the seat 10 using the electric device, the user can feel the presence of the cat in the vicinity of the part of the seat that moved.

By the heater 42 heating the part of the seat 10 corresponding to the position of the seat image G1 at which the character image G2 is present, the user can feel the warmth of the cat via the seat 10.

When the controller executes the second control or the third control, the electric device operates in an operation state not intended by the user in response to the user operating the operation unit; therefore, the entertainment value is increased.

When the second control is executed, the seat back 12 or the seat 10 moves in a direction opposite to a direction in which the seat back 12 or the seat 10 moves when the first control is executed; therefore, the entertainment value is increased.

The mode selecting switch 63 is provided to switch between a mode in which the second control is enabled and a mode in which the second control is disabled; therefore, the mode in which the second control is enabled and a mode in which the second control is disabled can be switched by the intention of the user.

In the cat mode, since one of the first control, the second control, and the third control is selected, the user does not know when the second control will be executed; therefore, the entertainment value is increased When the second control is selected in the cat mode, the user can understand through the screen SC that the electric device is operating in the operation state contrary to the intention of the user by the action of the cat displayed on the screen SC; therefore, the user can be soothed.

If the first control is selected in the cat mode, the cat moves the seat as intended by the user; therefore, the user can be soothed.

### Second Embodiment

Next, a second embodiment of the seat system will be described. Since the present embodiment is a slight modification of the process of the controller 100 according to the first embodiment, the same reference numbers will be used for substantially similar components and processes, and their descriptions will be omitted.

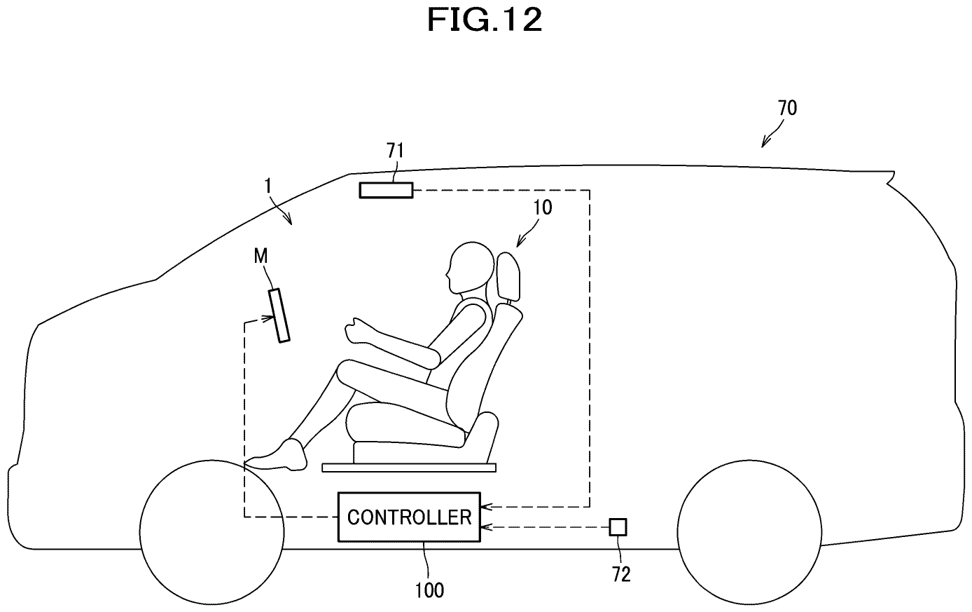

As shown in FIG. 12, in the second embodiment, the seat system 1 is provided in a vehicle 70. The vehicle 70 comprises, in addition to the seat system 1, a camera 71 as an example of a driving state detection unit and an accelerometer 72 as an example of a road condition detection unit.

The driving state detection unit may be, for example, a sensor for detecting a steering angle, an accelerator sensor, a brake sensor, or the like. The road condition detection unit may be a device that acquires map information for a navigation system.

The camera 71 has a function of detecting a driving state of the vehicle 70. In more detail, in the present embodiment, the camera 71 detects whether the vehicle 70 is traveling along a curve.

The accelerometer 72 has a function of detecting a road condition. In more detail, in the present embodiment, the accelerometer 72 detects whether the road on which the vehicle 70 is traveling or stopped is a slope.

The controller 100 acquires information from the camera 71 and the accelerometer 72. The controller 100 limits the movement of the electric device based on the driving state acquired from the camera 71 and the road condition acquired from the accelerometer 72. In more detail, the controller 100 disables the operation of the electric device when it is determined that the vehicle 70 is traveling along a curve or that the road is a slope.

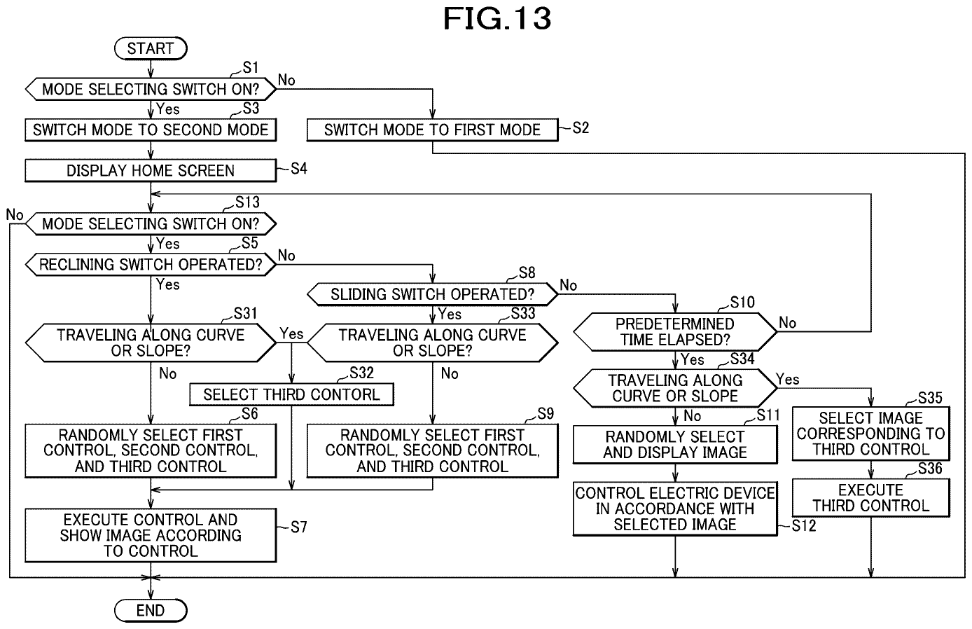

More specifically, the controller 100 executes a process shown in FIG. 13. The process of FIG. 13 is a process in which new steps S31 to S36 are added to the process of FIG. 4.

If it is determined in step S5 that the reclining switch 61 has been operated (Yes), the controller 100 determines whether the vehicle 70 is traveling along a curve or whether the road is a slope based on information from the camera 71 or the accelerometer 72 (S31). If it is determined step S31 that the vehicle 70 is traveling along a curve or the road is a slope (Yes), the controller 100 selects the third control (S32) to disable the operation of the electric reclining mechanism 21. After step S32, the controller 100 proceeds to the process of step S7, executes the third control, and displays on the screen SC the image matching the third control.

If it is determined in step S31 that the vehicle 70 is not traveling along a curve and the road is not a slope (No), the controller 100 proceeds to the process of step S6, and randomly selects the first control, the second control, or the third control.

If it is determined in step 8 that the sliding switch 62 has been operated (Yes), the controller 100 determines whether the vehicle 70 is traveling along a curve or whether the road is a slope based on information from the camera 71 or the accelerometer 72 (S33). If it is determined in step S33 that the vehicle 70 is traveling along a curve or the road is a slope (Yes), the controller 100 selects the third control (S32) to disable the operation of the electric sliding mechanism 30.

If it is determined in step 33 that the vehicle 70 is not traveling along a curve and the road is not a slope (No), the controller 100 proceeds to the process of step S9, and randomly selects the first control, the second control, or the third control.

If it is determined in step 10 that a predetermined period of time has elapsed (Yes), the controller 100 determines whether the vehicle 70 is traveling along a curve or whether the road is a slope based on information from the camera 71 or the accelerometer 72 (S34). If it is determined in step S34 that the vehicle 70 is traveling along a curve or the road is a slope (Yes), the controller selects the image corresponding to the third control (S35). After step S35, the controller 100 executes the third control (S36), and ends the process.

The following advantageous effects can be achieved by the second embodiment.

Since the operation of the electric device is disabled when the vehicle 70 is traveling along a curve movement that may make the user feel sick such as the seat back 12 unexpectedly tilting rearward when the vehicle 70 is traveling along a curve can be restrained. The comfort of the seat can thereby be increased.

Since the operation of the electric device is disabled when the vehicle 70 is traveling along a slope, movement that may make the user feel sick such as the seat back 12 unexpectedly tilting rearward when the vehicle 70 is located on a slope can be restrained. The comfort of the seat can thereby be increased.

The present disclosure is not limited to the above-described embodiments, and may be used in various embodiments such as exemplified below.

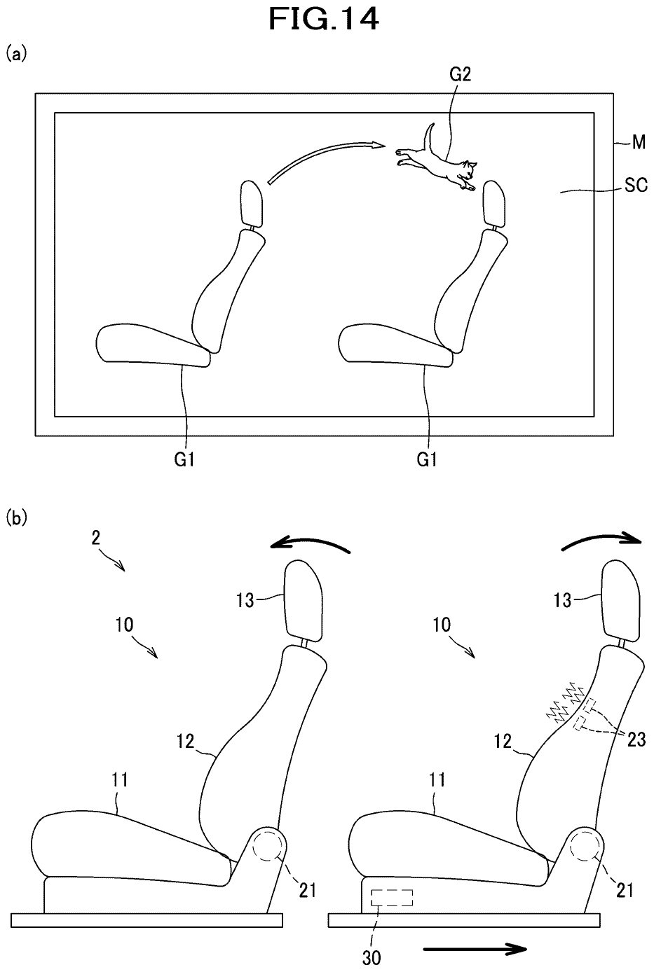

As shown in FIG. 14 (b), the seat system 2 may comprise a plurality of the seats 10. In this case, the controller 100 may select and display on the screen SC in step S11 an animation of the cat jumping from the front seat to the rear seat, as shown in FIG. 14 (a).

When the image of FIG. 14 (a) is selected, the controller 100 causes the seat back 12 of the front seat 10 to tilt forward by the electric reclining mechanism 21 in synchronization with the cat on the screen SC jumping from the front seat. The controller 100 causes the rear seat 10 to slide rearward by the electric sliding mechanism 30, causes the seat back 12 of the rear seat 10 to tilt rearward by the electric reclining mechanism 21, and operates the vibrating device 23 in synchronization with the timing of the cat on the screen SC landing on the rear seat.

In this embodiment, a plurality of the seats 10 is moved in synchronization with the movement of the cat on the screen SC; therefore, the entertainment value can be further increased. If the seat system comprises a plurality of the seats, one monitor may be provided for each of the seats. In this case, the monitor may be provided at the door adjacent to the seat.

In the above-described embodiment, in the second control, the first electric device (for example, the electric reclining mechanism 21) corresponding to the first operation unit (for example, the reclining switch 61) is operated in the second operation state. However, the controller may, for example, operate in the second control a second electric device which is normally not operable by the first operation unit and move the character image in accordance with the operation state of the second electric device.

In more detail, for example, when the reclining switch 61 is operated, the controller 100 may display on the screen SC the image shown in FIG. 7 (a) and cause the seat 10 to slide rearward by the electric sliding mechanism 30. When operating the second electric device in the second control, the first electric device may be in any state. For example, the first electric device may be in a state operated in the second operation state, in a non-operated state, or in a state operated in the first operation state.

In this embodiment, when the controller 100 executes the second control, the second electric device which is normally not operable by the first operation unit is operated if the user operates the first operation unit; therefore, the entertainment value may be increased.

Further, for example, the second electric device and the third electric device may be operated in the second control. In more detail, for example, when the reclining switch 61 is operated, the image shown in FIG. 9 (a) may be displayed on the screen SC and the air cell 22 and the heater 42 may be operated.

In this embodiment, when the second control is executed, two electric devices other than the first electric device is operated; therefore, the entertainment value may be increased.

The character image is not limited to a cat, and may be an image representing an animal other than humans. The character image may be an image representing humans. Even if the character image is an image representing a human, the controller may move a portion of the actual seat by the electric device in synchronization with the action of the human on the screen such as hitting the seat, which enables the user to interact with the human on the screen via the seat.

The character image may be an image smaller than the seat image or may be an image larger than the seat image. If the character image is an image smaller than the seat image, the variety of the actions performed by the character may be increased, such as the character being placed on the seat and the character sneaking under the seat.

The number and positions of the electric devices may be changed as desired.

The electric device that moves at least a portion of the seating surface of the seat cushion upward is not limited to air cells, and, for example, may be an electric tilt-up mechanism or an electric height mechanism. The entire seating surface of the seat cushion is moved upwards when the electric device is the electric tilt-up mechanism or the electric height mechanism.

The condition for executing the image-seat linking process when no operation command for operating the electric device is not limited to time, and for example may be a condition such as the vehicle being stopped.

The electric device that moves the predetermined portion of the seat between the first position and the second position is not limited to the air cell, and for example, may be an electric lumbar support that supports the driving posture of the user.

If the vehicle may execute autonomous driving, the controller may disable the second control during manual driving and enable the second control during autonomous driving. The controller may enable the second control during auto-cruise on the highway and disable the second control at times other than auto-cruise. The controller may enable the second control while the car is stopped and disable the second control while the car is driven.

The system comprising the controller that executes the image-seat linking process may be a system that does not comprise the seat. For example, the system may comprise an interior member of a vehicle, an electric device that moves a portion of the interior member, a controller that controls the electric device, and a screen.

The image displayed on the screen is not limited to the seat image, and may be a user image representing the user. In this case, if the character image performs an action on a portion of the user image, a portion of the seat corresponding to the portion of the user image may be moved by the electric device. In more detail, for example, an animation of a cat alternately stepping on the lower back of the user using its left-and right paws may be played on the screen and air cells located at a portion of the seat back (corresponding to the lower back of the user) may be inflated and deflated.

The electric device is not limited to the above-described embodiments, and may, for example, be a blower, a light, a device for generating scent, and a device for rotating the seat about a vertical axis. If a blower is provided in the seat and wind from the blower can be blown out from the seating surface toward the user, the blower may be operated when displaying the image shown in FIG. 9 (a). In this case, the wind of the blower may simulate the breathing of the cat.

The function of the controller executing the first control or the second control based on the operation command from the operation unit is applicable to any object comprising an electric device, not only to the seat. For example, if the function is applied to a vehicle, the vehicle may be configured such that when the user operates an air conditioner switch provided in the vehicle to raise the temperature, the set temperature will increase as normal when the first control is executed, and the set temperature will decrease when the second control is executed.

The operation unit may be a microphone that outputs an operation command in response to audio input, or may be a device that captures the gesture of the user (body movement) and outputs an operation command corresponding to the gesture.

The seat may be a vehicle seat used in an automobile, or may be a vehicle seat other than an automobile seat such as a seat used in ships or aircrafts. Further, the seat is not limited to a vehicle seat, and may, for example, be a legless chair, a seat used as furniture or used outdoors, a chair for hospital waiting rooms, a park bench, a bed, or a mattress.

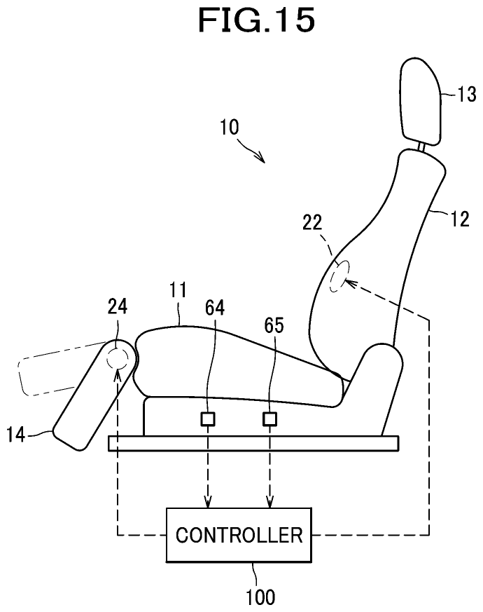

As shown in FIG. 15, the seat 10 may further comprise an ottoman 14 that supports the calves of the user, an ottoman operation device 24 that causes the ottoman to rotate, an ottoman operating switch 64 for operating the ottoman operation device 24, and an air cell switch 65 for operating an air cell 22 used as lumbar support. In this case, the controller 100 may operate at least one of the ottoman operation device 24 or the air cell 22 in synchronization with the action of the character displayed on the display.

Further, in this case, the controller 100 may execute a first control corresponding to the operation command from the ottoman operating switch 64, and a second control that does not correspond to the operation command from the ottoman operating switch 64. Similarly, the controller 100 may execute a first control corresponding to the operation command from the air cell switch 65, and a second control that does not correspond to the operation command from the air cell switch 65.

The seat may comprise a center-folding mechanism, a switch for operating the folding mechanism, a headrest moving mechanism, a switch for operating the headrest moving mechanism, and the like. Here, the center-folding mechanism is, for example, a mechanism configured to tilt the upper portion of the seat back forward and rearward with respect to the lower portion of the seat back. The headrest moving mechanism is a mechanism that causes the headrest to move in the up-down direction and the front-rear direction. In this case as well, the controller may execute the first control corresponding to the operation command from each switch and the second control that does not correspond to the operation command from each switch.

The display may be, for example, a smartphone, a tablet, a head-mounted display used for virtual reality, and a monitor for a car navigation system. The display may also be a panel that displays images such as speedometer, a device for displaying images on windows such as the windshield, or a projector incorporated in the headlight that displays images on the road surface.

The character displayed on the screen may be changed by the selection of the user. In this case, the actions may be changed for each character. The types of the electric actuators that are operated, the frequency of operating the electric actuators, and the magnitude of the output of the electric actuators may be set for each character.

For example, if the character is a bird, the electric device (for example, a speaker or an air cell) located at the headrest or the shoulders may be operated more frequently than other characters. Further, if the character is a bird, the amount of movement of the portion of the seat that moves in synchronization with the action of the character may be made smaller compared to when the character is an animal larger than the bird such as a cat. If the character is an animal larger than a cat such as a dog, the portion of the seat that moves in synchronization with the action of the character may be moved faster. If the character is a reptile such as a snake, the temperature of the heater may be made lower compared to when the character is a mammal.

An image of the character operating the steering wheel may be displayed on the screen during auto-cruise.

The positional relationship with the surrounding cars may be detected by sensors such as cameras, and the operation of the electric devices may be limited based on the positional relationship.

The way that the controller controls the operation while driving may be different for the driver's seat and the seats other than the driver's seat. For example, the driver's seat may only be switched between the first mode and the second mode when stopped, and the other seats may always be switchable between the first mode and the second mode.

When collision is detected or predicted, the controller may stop displaying the image and operating in the second mode and activate the safety device.

The amount of movement and the speed of the portion of the seat that moves in synchronization with the action of the character may be set depending on the physique of the user. For example, the amount of movement and the speed of the portion of the seat may be set to be smaller as the physique of the user becomes larger (heavier). A physique detector for detecting the physique of the user may, for example, be a pressure sensor that detects the pressure from the seating surface of the seat, an electromagnetic sensor, or photographing equipment such as cameras.

The electric device to be operated may be selected depending on the physique of the user. For example, when the air cell of the seat cushion is operated in synchronization with the action of the cat sneaking under the seat, only one cell may be operated if the weight of the user is smaller than or equal to a predetermined value and two air cells may be operated if the weight of the user is larger than the predetermined value.

When biometric information of the user is detected and fatigue is sensed, the seat may be moved to relieve fatigue and an image corresponding to the operation may be displayed. The sensor for detecting the biometric information may be a sensor for detecting at least one of brain waves, facial expressions, eye gaze, respiration, heart rate, or pulse rate. The movement of the seat intended to relieve fatigue may be, for example, movement of the seat giving a massage to the user by operating the air cell of the seat. The displayed image corresponding to this operation may be, for example, an animation of a cat massaging a part of the body of the user.

The controller may propose various modes to the user such as a play mode, a fatigue relieving mode, a soothing mode, and a lulling mode. When there is a plurality of seats, the mode may be switchable for each seat. When in the soothing mode or the lulling mode, the controller may operate the air cell of the seat back in synchronization with the breathing of the user to lull the user to sleep. In the soothing mode or the lulling mode, the controller may display on the display an animation of the cat moving its left and right paws and alternately pushing the seat back from the rear.

The actions of the character and the messages may be changed according to brain waves, facial expressions, eye gaze, and respiration of the user. The controller may recommend characters matching the preference of the user based on user information such as the gender and age of the user. The controller may acquire the user information, for example, from the smartphone of the user.

The controller may determine the user based on the user information and set the audio output of the character according to an intimacy level with the user. The intimacy level may, for example, increase the longer the user executes the cat mode. The controller may set the message of the character to become gentler as the intimacy level increases.

The lighting attached to the seat may operate in accordance with what is displayed on the display and the operation of the seat.

The following method is an example of a method for manufacturing the seat system.

A method for manufacturing a seat system is provided. The seat system comprises a seat for a user to be seated, an electric device that moves a predetermined portion that is a portion of the seat, a controller that controls the electric device, and a display. The controller is configured to execute an image-seat linking process in which the controller displays a seat image representing the seat and a character image on the display, and moves the predetermined portion by the electric device in synchronization with the action of the character image. The method for manufacturing the seat system comprises a step of mounting the electric device on the members constituting the seat, and a step of mounting the controller on the members constituting the seat.

The following method is an example of a method for manufacturing the seat.

A method for manufacturing a seat is provided. The seat comprises a first electric device configured to operate when energized and a second electric device configured to operate when energized, a first operation unit configured to operate the first electric device, and a controller configured to operate the first electric device based on a first operation command from the first operation unit. The controller is configured to select and execute a first control, in response to receiving the first operation command from the first operation unit, in which the controller operates the first electric device in a first operation state corresponding to the first operation command, and a second control, in response to receiving the first operation command from the first operation unit, in which the controller operates the first electric device in a second operation state that does not correspond to the first operation command and/or operates the second electric device. The method for manufacturing the seat comprises a step of mounting the first electric device on the members constituting the seat, a step of mounting the second electric device on the members constituting the seat, a step of mounting the first operation unit on the members constituting the seat, and a step of mounting the controller on the members constituting the seat.

### Third Embodiment

Next, a third embodiment of a seat system as an example of an interior system will be described with reference made to the attached drawings.

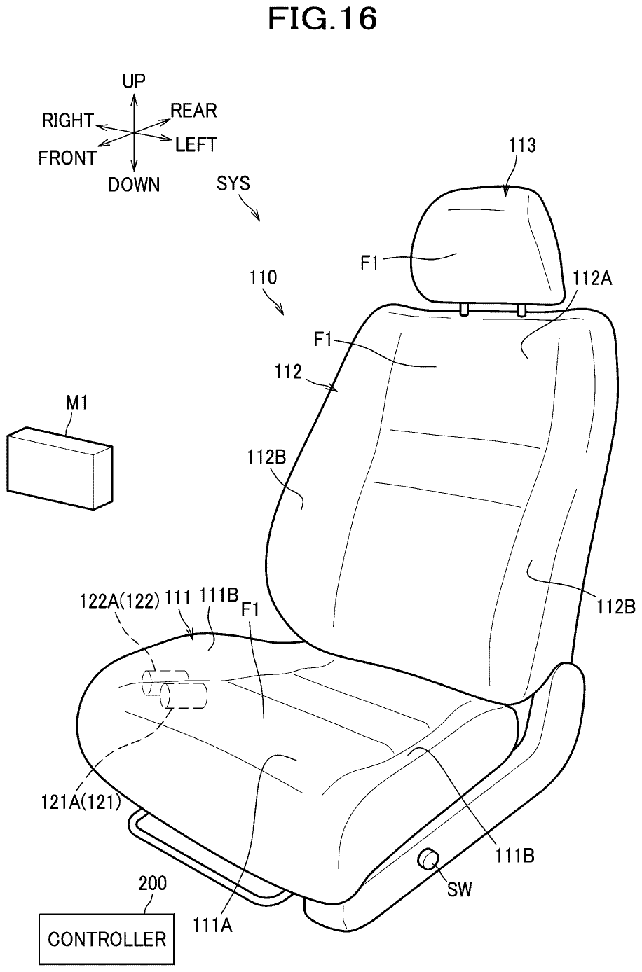

As shown in FIG. 16, the seat system SYS comprises a seat 110 as an example of an interior member, a monitor M1 as an example of a display, and a controller 200. The seat 110 comprises a seat cushion 111, a seat back 112, and a headrest 113. The seat cushion 111, the seat back 112, and the headrest 113 constitutes a seat body on which the user can be seated. The seat cushion 111, the seat back 112, and the headrest 113 each has a seating surface F1 that contacts the user seated on the seating surface F1.

The seat cushion 111 comprises a base portion 111A located in a laterally central portion of the seat cushion 111A and projecting portions 111B disposed laterally outward of the base portion 111A on both lateral sides of the base portion 111A. The base portion 111A contacts and supports the buttocks and the thighs of the user from below. The projecting portions 111B project from the base portion 111A toward the user to support the sides of the thighs and the buttocks of the user.

The seat back 112 similarly comprises a base portion 112A located in a laterally central portion of the seat back and projecting portions 112B disposed laterally outward of the base portion 112A on both lateral sides of the base portion 112A. The base portion 112A contacts and supports the back of the user from the rear. The projecting portions 112B project toward the user to support the sides of the upper body of the user.

As shown in FIG. 17 (a), the seat cushion 111 comprises a frame FL1, a pad P, and a covering SK1. The frame FL1 is, for example, made of metal and supports the pad P. The pad P is made of cushioning material such as urethane foam. The outer covering SK1 is made of synthetic leather, fabric, and the like, and covers the pad PD. Similarly, the seat back 12 and the head rest 13 each comprises a frame, a pad, and an outer covering.

The pad P of the seat cushion 111 includes a first portion P1 and a second portion P2. The first portion P1 is located on the lateral edges of the base portion 111A.

The second portion P2 is locate at each of the laterally inner side of each of the projecting portions 111B. The second portion P2 is adjacent to the first portion P2 in the lateral direction.

A groove G for tucking in the outer covering SK1 is formed between the first portion P1 and the second portion P2. The second portion P2 nips an object in combination with the first portion P1.

The seat cushion 111 further comprises a first air cell 121 and a second air cell 122 as examples of the electric devices, a first pressure sensor 131 and a second pressure sensor 132 as examples of the sensors, and a first heater 141 and a second heater 142.

The first air cell 121 comprises a bag 121A that can be inflated and deflated, and an air pump and a tube not shown in the drawings. The air pump has a function of pumping air into the bag 121A and sucking out air from the bag 121A, and operates when energized. The tube connects the bag 121A and the air pump.

The bag 121A is embedded within the pad P. The air pump is, for example, fixed to the frame of the seat 110.

The second air cell 122 has a structure approximately similar to the first air cell 121, and comprises a bag 122A, an air pump, and a tube.

The bag 121A of the first air cell 121 is located in the base portion 111A. The bag 121A of the first air cell 121 is located laterally inward of the first portion P1. In other words, the first portion P1 is located between the bag 121A of the first air cell 121 and the second portion P2. Thus, the first air cell 121 can push the first portion P1 toward the second portion P2 (see FIG. 17 (b)).

The bag 122A of the second air cell 122 is located in the projecting portion 111B. The bag 122A of the second air cell 122 is located laterally outward of the second portion P2. In other words, the second portion P2 is located between the bag 122A of the second air cell 122 and the first portion P1. Thus, the second air cell 122 can push the second portion P2 toward the first portion P (see FIG. 17 (b)).

The first pressure sensor 131 and the second pressure sensor 132 are sensors that detect an object located between the first portion P1 and the second portion P2. The first pressure sensor 131 and the second pressure sensor 132 are sensors that detect the pressure between the first portion P1 and the second portion P2.

The first pressure sensor 131 is located in the first portion P1 and the second pressure sensor 132 is located in the second portion P2. In other words, the first portion P1 comprises the first pressure sensor 131 and the second portion P2 comprises the second pressure sensor 132.

The first heater 141 and the second heater 142 are heaters that heat the space between the first portion P1 and the second portion P2. The first heater 141 is located in the first portion P1 and the second heater 142 is located in the second portion P2. In other words, the first portion P1 comprises the first heater 141 and the second portion P2 comprises the second heater 142.

More specifically, the first heater 141 is located between the bag 121A of the first air cell 121 and the first pressure sensor 131. The second heater 142 is located between the bag 122A of the second air cell 122 and the second pressure sensor 132.

Referring back to FIG. 16, the seat 110 further comprises a mode selecting switch

The mode selecting switch SW is a switch for switching the mode of the controller 200 to a first mode and to a second mode. The mode selecting switch SW is, for example, a push-button switch. Each time the mode selecting switch SW is pushed by the user, the mode selecting switch 63 is alternately switched to an ON state and to an OFF state.

The controller 200 comprises components such as a Central Processing Unit (CPU), a Read Only Memory (ROM), a Random Access Memory (RAM), and the like. The controller 200 may be provided at the seat 110, or at a member other than the seat 110.

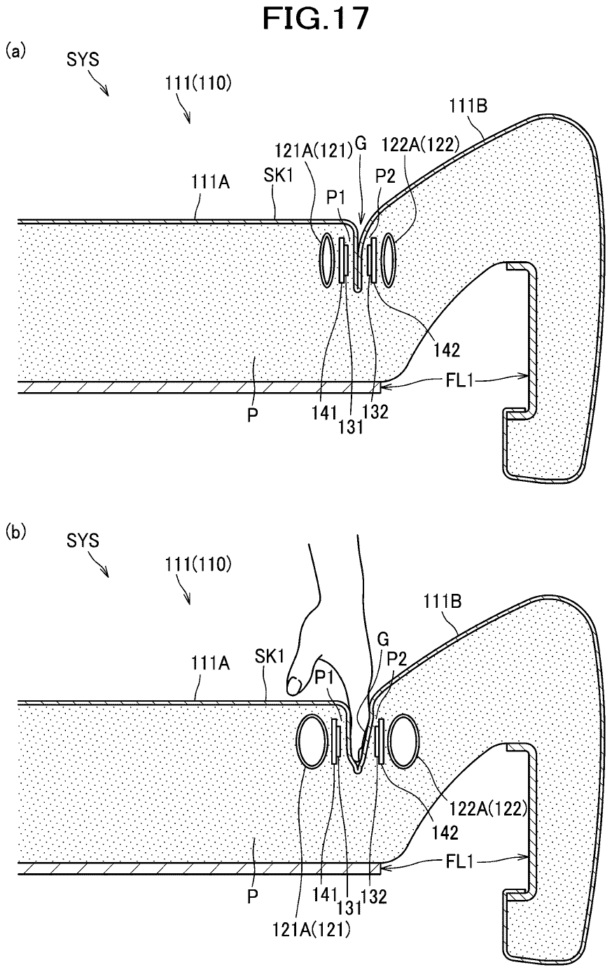

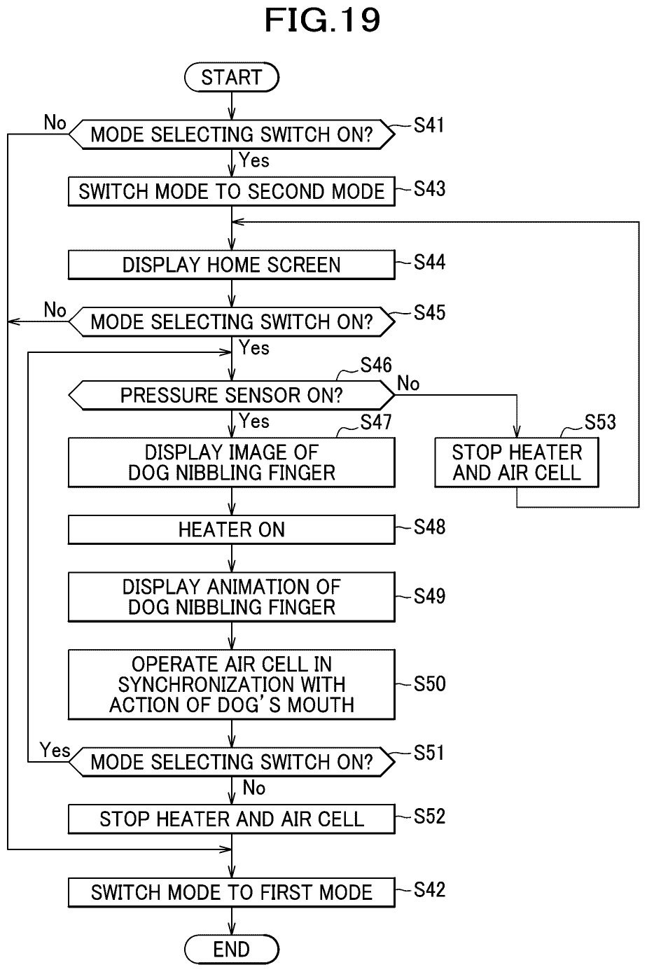

As shown in FIG. 18, the controller 200 is connected to the monitor M1, each of the pressure sensors 131 and 132, the mode selecting switch SW, each of the air cells 121 and 122, and each of the heaters 141 and 142. The monitor M1 can display a character of a dog as shown in FIG. 20.

The controller 200 controls each of the air cells 121 and 122 based on information from each of the pressure sensors 131 and 132. More specifically, if the controller 200 determines that an object is located between the first portion P1 and the second portion P2 based on information from each of the pressure sensors 131 and 132 when each of the air cells 121 and 122 is not operated, the controller 200 operates each of the air cells 121 and 122 so that the first portion P1 is pressed against the second portion P2 and the second portion P2 is pressed against the first portion P1.

The controller 200 is switchable between the first mode and the second mode by the mode selecting switch SW. The first mode is a mode in which the first air cell 121 and the second air cell 122 are not operated even if the user puts their finger in the space between the first portion P1 and the second portion P2. In the following descriptions, the first mode is also referred to as “normal mode”.

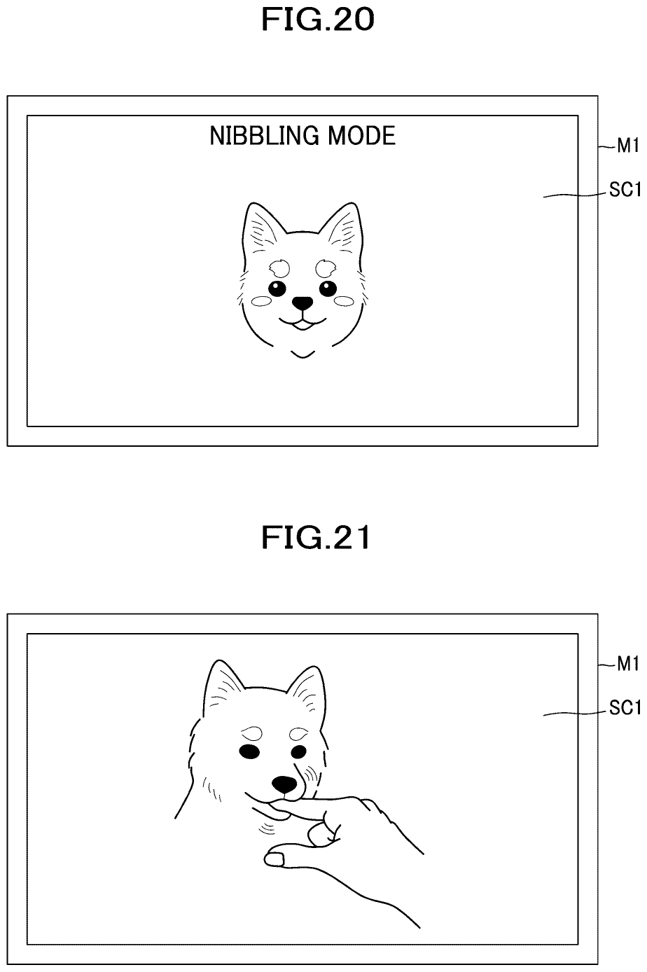

The second mode is a mode in which each of the air cells 121 and 122 are operated to match an animation of a dog nibbling a finger of a person played on the screen SC1 of the monitor M1 as shown in FIG. 21 when the user puts their finger in the space between the first portion P1 and the second portion P2, so that the user can feel as if a dog is nibbling on their finger. In the following descriptions, the second mode will also be referred to as “nibbling mode”. In the nibling mode, the controller 200 operates the air cells 121 and 122 in synchronization with the movement of the mouth of the character displayed on the monitor M1.

Next, the operation of the controller 200 will be described in detail.

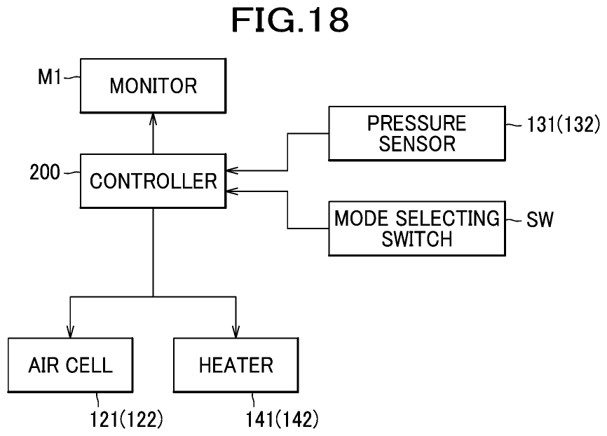

The controller 200 repeatedly executes the process shown in FIG. 19. In the process shown in FIG. 19, the controller 200 first determines whether the mode selecting switch SW is ON (S41). If it is determined in step S41 that the mode selecting switch SW is not ON (No), the controller 200 switches the mode to the first mode, i.e., the normal mode (S42), and ends the process.

If it is determined in step S41 that the mode selecting switch SW is ON (Yes), the controller 200 switches the mode to the second mode, i.e., the nibbling mode (S43), and displays on the screen SC1 the home screen shown in FIG. 20 (S44). After step S44, the controller 200 determines whether the mode selecting switch SW is ON (S45).

If it is determined that the mode selecting switch SW is ON in step S45 (Yes), the controller 200 determines whether at least one of the two pressure sensors 131 and 132 is switched ON (S46). Here, the pressure sensor being switched ON means that a pressure value detected by the pressure sensor becomes greater than or equal to a first threshold value. If it is determined that the mode selecting switch SW is not ON in step S45 (No), the controller 200 proceeds to the process of step S42.

If it is determined in step S46 that at least one of the pressure sensors 131 and 132 is switched ON (Yes), the controller 200 displays on the screen SC1 an image of a dog nibbling a finger as shown in FIG. 21 (S47). After step S47, the controller 200 turns ON the heaters 141 and 142 (S48). In more detail, the controller 200, for example, controls the heaters 141 and 142 in step S48 so that the temperature of the space between the first portion P1 and the second portion P2 is equivalent to the body temperature of a dog. In this case, for example, a temperature sensor for detecting the temperature of the space between the first portion P1 and the second portion P2 may be provided on the seat 110, and the controller may control the heaters 141 and 142 so that the temperature acquired from the temperature sensor reaches the target temperature.

After step S48, the controller 200 plays on the screen SC1 an animation of the dog moving its mouth as if it nibbling a finger (S49). After step S49, the controller 200 operates the air cells 121 and 122 in synchronization with the movement of the mouth of the dog on the screen SC1 (S50). In more detail, the controller 200 controls the air pumps of the air cells 121 and 122 so that if the mouth of the dog on the screen SC1 moves in a direction that closes, the bags 121A and 122A are inflated and if the mouth of the dog on the screen SC1 moves in a direction that opens, the bags 121A and 122A are deflated.

After step 50, the controller 200 determines whether the mode selecting switch SW is ON (S51). If it is determined in step S51 that the mode selecting switch SW is ON (Yes), the controller 200 returns to the process of step 46.

If it is determined in step S51 that the mode selecting switch SW is not ON (No), the controller 200 turns off the heaters 141 and 142 and the air cells 121 and 122 (S52), and proceeds to the process of step S42. If it is determined in step S46 that both of the pressure sensors 131 and 132 are not ON (No), the controller 200 turns off the heaters 141 and 142 and the air cells 121 and 122 (S53), and returns to the process of step S44. When the air cells 121 and 122 are switched off in steps S52 and S53, the controller 200 deflates the bags 121A and 122A to their minimal size and then stops the operation of the air pump.

Next, an example of the operation of the controller 200 will be described in detail.

As shown in FIG. 16, when the user seated on the seat 110 switches the mode selecting switch SW to ON, the controller starts the nibbling mode and displays on the screen SC1 of the monitor M1 the home screen shown in FIG. 20 (S41: Yes→S43→S44). A message or an illustration prompting the user to perform an action, such as “Please insert your finger in the tuck-in groove on the right side”, may be displayed on the home screen.

As shown in FIG. 17 (b), when the user inserts their finger in the groove G in the nibbling mode, the first portion P1 and the second portion P2 are pushed laterally outward, and the pressure sensors 131 and 132 are turned ON. When the finger is inserted into the groove G, the air cells 121 and 122 are not yet operated; therefore, the pressure sensors 131 and 132 detect the finger between the first portion P1 and the second portion P2 when the air cells 121 and 122 are not operated.

When the controller 200 determines that the finger is inserted in the groove G by the pressure sensors 131 and 132 being turned ON, the controller 200 turns ON the heaters 141 and 142 and displays on the screen SC1 of the monitor M1 an animation of a dog nibbling on a finger shown in FIG. 21, and operates the air cells 121 and 122 in synchronization with the movement of the mouth of the dog on the screen SC1 (S46: Yes→S47 to S50).

When the user pulls out their finger from the groove, the pressure sensors 131 and 132 are turned OFF (the pressure values become smaller than the threshold value), and the controller 200 turns off the heaters 141 and 142 and the air cells 121 and 122 and returns the display of the screen SC1 to the home screen (S46: No→S53→S44).

If the user switches OFF the mode selecting switch SW during the nibbling mode, the controller 200 determines No in step S45 or step S51 and returns the mode to the normal mode (S42).

According to the present embodiment, the following advantageous effects can be acquired.

When a finger is inserted between the first portion P1 and the second portion P2, the controller 200 operates the air cells 121 and 122 and the finger is squeezed between the first portion P1 and the second portion P2; therefore, the entertainment value of the seat 110 can be increased.

The air cells 121 and 122 operate in synchronization with the movement of the mouth of the dog displayed on the monitor M1; therefore, the user can feel that their finger is being nibbled by a dog and be soothed.

The air cells 121 and 122 are operated in response to the pressure sensors 131 and 132 detecting a finger; therefore, the air cells 121 and 122 can be operated and stopped in response to the finger being inserted into and pulled out from the space between the first portion P1 and the second portion P2.

The temperature inside the groove G may be heated to a temperature equivalent to a body temperature of a dog by the heaters 141 and 142; therefore, the user can feel reality in their finger being nibbled by a dog.

The present disclosure is not limited to the above-descried embodiments, and may be used in various embodiments as given below. In the following descriptions, the structures approximately similar to the above-described embodiments will be identified by the same reference numbers and descriptions thereof will be omitted.

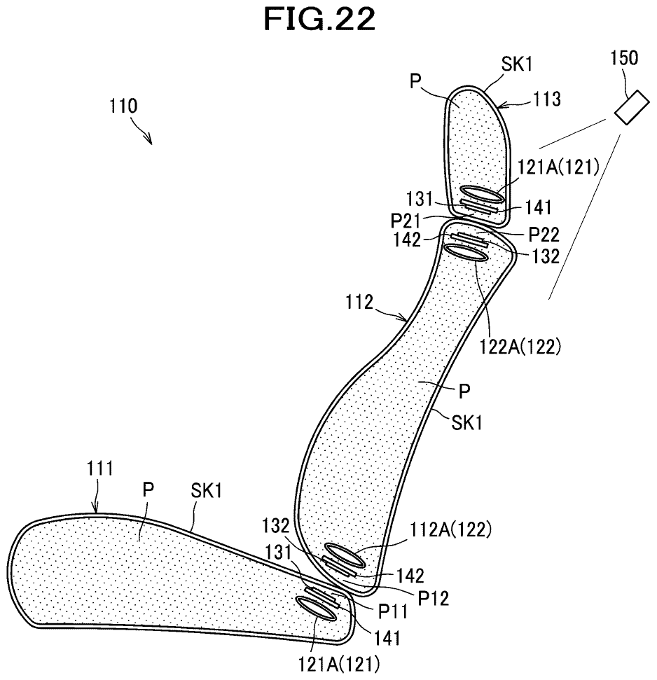

The first portion and the second portion that can nip an object in combination is not limited to portions forming the tuck-in groove as in the above-described embodiment. For example, as shown in FIG. 22, the first portion P11 may be a part of the pad P of the seat cushion 111, and the second portion P12 opposed to the first portion P11 may be a part of the pad P of the seat back 112. In this case, the seat cushion 111 may comprise the first portion P11 and may comprise the above-described first air cell 121, the first pressure sensor 131, and the first heater 141 as well. The seat back 112 may comprise the second portion P12 and may comprise the above described second air cell 122, the second pressure sensor 132, and the second heater 142 as well.

This embodiment can also enable the user to feel that a dog is nibbling their finger when the user inserts their finger between the first portion P11 of the seat cushion 111 and the second portion P12 of the seat back 112; therefore, the entertainment value of the seat 110 can be increased.

Further, for example, the first portion P21 may be a part of the pad P of the headrest 113 and the second portion P22 opposed to the first portion P21 may be a part of the pad P of the seat back 112. In this case, the head rest 113 may comprise the first portion P21 and may comprise the above-described first air cell 121, the first pressure sensor 131, and the first heater 141 as well. The seat back 112 may comprise the second portion P22 and may comprise the above-described second air cell 122, the second pressure sensor 132, and the second heater 142 as well.

This embodiment can also enable a user to feel that a dog is nibbling their finger when the air cells 121 and 122 are operated in response to the user inserting their finger between the first portion P21 of the headrest 113 and the second portion P22 of the seat back 112; therefore, the entertainment value of the seat 110 can be increased.

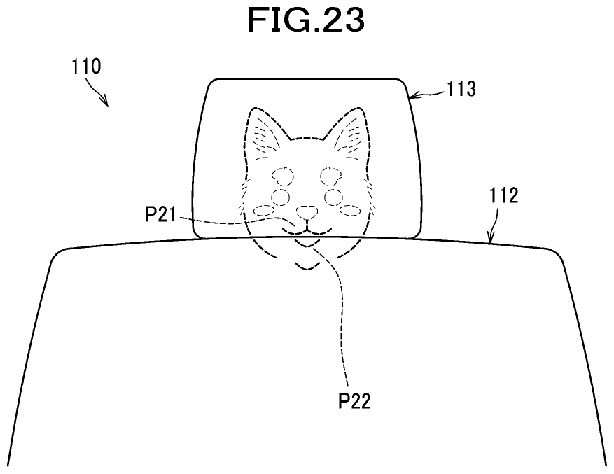

The display is not limited to the monitor M1, and may, for example be a projector 150 shown in FIG. 22. The projector 150 projects an image of a dog character on the surface of the seat 110 as shown in FIG. 23. In this case, it would be desirable to project image of the face of the dog across the headrest 113 and the seat back 112 such that the mouth of the dog projected on the surface of the seat 110 is located between the first portion P21 and the second portion P22. In this embodiment, similar to the above-described embodiment, the user can more realistically feel that a dog is nibbling their finger when the air cells 121 and 122 are operated in synchronization with the action of the mouth of the dog projected on the surface of the seat 110.

It is sufficient if the unit for nipping the object comprises at least the first portion, the second portion, and the electric device, and the sensor and the heater may be omitted. If the unit does not comprise the sensor, the electric device may be operated by the user operating an operation member (for example, a starting switch for the electric device).

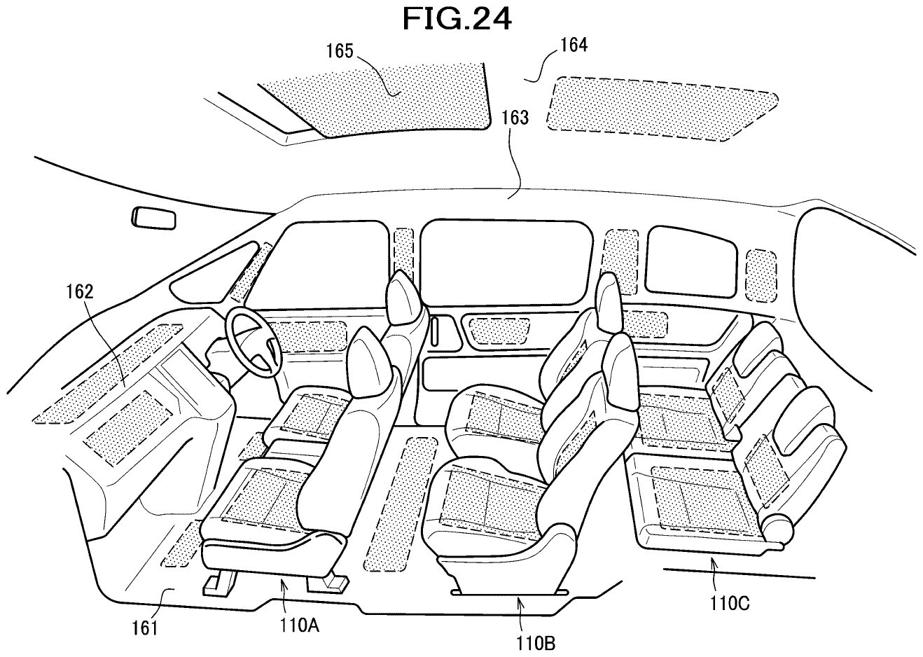

The seat comprising the unit may be a vehicle interior member constituting an interior of the vehicle as shown in FIG. 24. In this case, the seat comprising the unit may be a seat 110A in the first row, a seat 110B in the second row, or a seat 110C in the third row. The groove between the first portion and the second portion may be disposed, for example, on the seating surface of the seats 110A to 110C shown by the dots.

The unit may be provided on a vehicle interior member other than the seat.

Examples of the vehicle interior members on which the unit may be provided include a vehicle floor 161, a dashboard 162, inner panels 163 of doors or inner side walls of the vehicle, a roof 164, and a cover 165 for opening and closing the sun roof. The groove between the first portion and the second portion may be located on surfaces shown by the dots in the figure. The vehicle interior member may also be a steering wheel, a console, an instrument panel, etc.

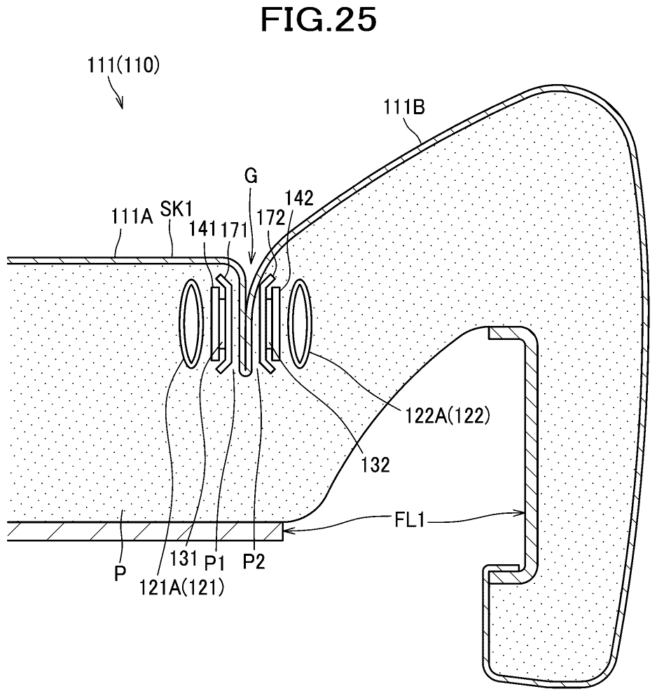

As shown in FIG. 25, the first portion P1 may comprise a first plate member 171 that is harder than the outer covering SK1. The second portion P2 may comprise a second plate member 172 that is harder than the outer covering SK2.

The first plate member 171 is located between the groove G and the first pressure sensor 131. The second plate member 172 is located between the groove G and the second pressure sensor 132. Each of the plate members 171 and 172 includes a surface facing the groove G, and the upper end portions and the lower end portions of each of the plate members 171 and 172 are bent in a direction away from the groove G.

The first portion and the second portion are not limited to parts of the pads, and may, for example, be parts of the aforementioned plate members 171 and 172 or parts of the bags of the air cells. If the first portion and the second portion are parts of the plate members or the bags of the air cells, the user may feel the pressure more easily since the parts of the plate members or the bags of the air cells are harder than the outer covering of the seat. The stiff members which are harder than the outer covering of the seat may be curved or may be a flat plate member.

The first portion and the second portion may comprise electrostatic discharge pads that contact the object inserted between the first portion and the second portion. In this case, for example, static electricity can be discharged from the user's fingers when they are inserted between the first portion and the second portion. The first portion and the second portion may comprise abrasive material that contacts the object inserted between the first portion and the second portion. In this case, for example, the user may polish their nails using the abrasive material when inserting their fingers between the first portion and the second portion.

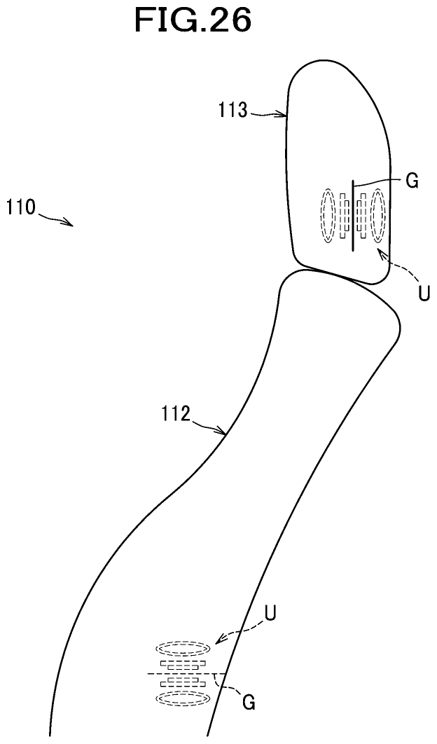

As shown in FIG. 26, the unit U for nipping an object may be provided on the headrest 113, or may be provided on the seat back 112. When the unit U is provided on the headrest 113, the groove G may, for example, be formed in each of the lateral side surfaces of the headrest 113. When the unit U is provided on the seat back 112, the groove G may, for example, be formed in the rear surface of the seat back 112.

Further, the unit may be provided on the forward end portion of the armrest of the seat or the door, a lower surface of the forward end portion, or a side surface of the forward end portion. The unit may be provided on the projecting portion of the seat, a groove of the seat back, or a rear surface of the headrest.

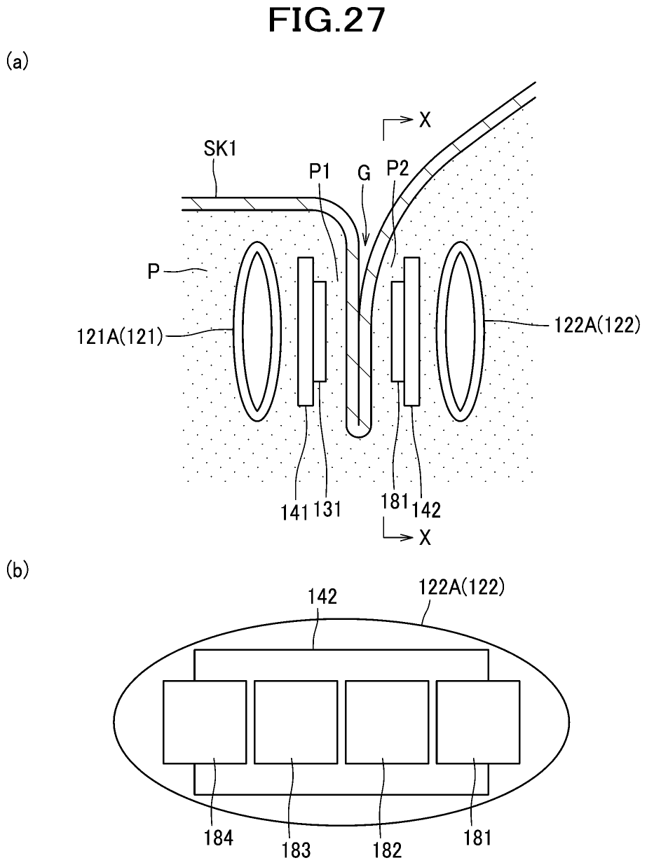

As shown in FIG. 27 (a) and (b), a plurality of sensors 181 to 184 may be provided for one portion (for example, the second portion P2). The sensors 181 to 184 are sensors for detecting an object inserted in the groove G, and, for example, are pressure sensors.

In this case, the controller may set the operation pattern of the air cells 122 based on information from each of the sensors 181 to 184. In more detail, for example, the first threshold value for determining that an object has been inserted between the first portion P1 and the second portion P2 may be set at a different value for each of the sensors 181 to 184. The controller may determine whether the pressure value has become greater than or equal to the first threshold value for each of the sensors 181 to 184, and, depending on the number and positions of the sensors of which the pressure values have become greater than or equal to the threshold value, the controller sets the number of times the first portion P1 and the second portion P2 nips the object or the nipping time from when the pressure on the object increases to the maximum value to when the pressure on the object decreases to the minimal value.

For example, when the controller determines that the pressure values at the first sensor 181 and the third sensor 183 become greater than or equal to a first threshold value, the controller sets the number of times the object is nipped to a predetermined number and extends the nipping time to a time longer than other cases. In this control, the controller may slow down the speed the object is nipped compared to other cases. Further, when the controller determines that the pressure value at the second sensor 182 and the third sensor 183 becomes greater than or equal to a first threshold value, the controller may alternately execute a strong nip control in which the maximum pressure value on the object becomes a first maximum value and a weak nip control in which the maximum pressure value on the object becomes a second maximum value that is smaller than the first maximum value.

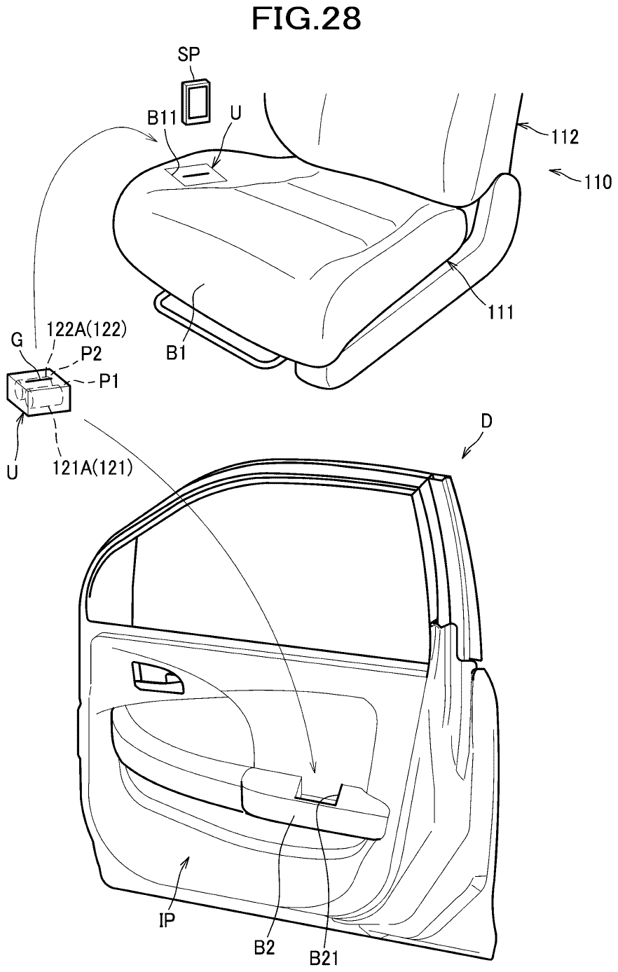

As shown in FIG. 28, the seat cushion 111 may comprise a unit U including a first portion P1, a second portion P2, and air cells 121 and 122 (bags 121A and 122A), and a base portion B1 to which the unit U is attachable to and removable from. In this case, for example, the inner panel IP of the door D may comprise a base portion B2 to which the unit U is attachable to and removable from. The base portions B1 and B2 may each include recesses B11 and B21 to which the unit U can be fitted.

In this structure, the tubes for each of the air cells 121 and 122 may be disposed in the unit U and the base portions B1 and B2 and the tubes on the side of the unit U and the tubes on the sides of the base portions B1 and B2 may be attachable and detachable via joints. If the unit U comprises a sensor, the wiring connecting the sensor and the controller may be disposed in the unit U and the base portions B1 and B2 and the wiring on the side of the unit U and the wiring on the sides of the base portions B1 and B2 may be attachable and detachable via a connector. The unit U may or may not comprise the outer covering SK.

According to this configuration, the unit U is interchangeably attachable to the seat 110 and the door D; therefore, for example, if the unit U holds belongings of the user such as a smartphone SP, the belongings of the user may be moved with the unit U, and the belongings may be positioned according to the user's preference. Further, the user may position the unit U in a preferred position and enjoy the nibbling mode. Additionally, since the unit U is detachable from the base portions B1 and B2, the unit may be easily replaced.

The unit detachable from the base portion may comprise the first portion, the second portion, the sensor, the electric device, the controller, and a battery. According to this configuration, the unit may be detached from the base portion and be used separately. In this case, a contact type or non-contact type charger for charging the battery of the unit may be provided on the base portion.

The electric device may be any device that is configured to cause at least one of the first portion or the second portion to be pressed against the other one of the first portion or the second portion, such as a linking mechanism, a cylinder, a solenoid, or a cam rotated by a motor. The electric device may have a structure comprising a mechanism such as a vice that clamps both the first portion and the second portion.

The display may be a smartphone, a tablet, a head-mounted display used for virtual reality, or a monitor for a car navigation system. The display may also be a panel that displays images such as speedometer, a device for displaying images on windows such as the windshield, or a projector incorporated in the headlight that displays images on the road surface.

The controller may set the operation pattern of the electric device according to the magnitude of the pressure acquired from the pressure sensor. For example, the controller may set a maximum pressure applied to the object at a first pressure value when the pressure acquired from the pressure sensor is smaller than a second threshold value, and may set a maximum pressure applied to the object at a second pressure value greater than the first pressure value when the pressure value acquired from the pressure sensor is greater than or equal to the second threshold value. Here, the second threshold value is greater than the first threshold value for determining that an object is inserted between the first potion and the second portion. The second pressure value may be a value smaller than the first pressure value.

According to this configuration, when pressure changes in response to the movement of the finger of the user inserted between the first portion and the second portion, the operation pattern of the electric device is set according to the magnitude of the pressure; therefore, the entertainment value may be increased.

The sensor may be a capacitive sensor that detects objects based on a change in the capacitance when an object enters the electric field or a resistive touch sensor.

The sensor may be a biometric information detection sensor that detects biometric information. In this case, the controller may set the operation pattern of the electric device depending on the biometric information acquired from the biometric information detection sensor.

Examples of the biometric information are brain waves, blood oxygen level, heart rate, blood pressure, blood glucose level, pulse rate, body temperature, and perspiration. For example, the controller may acquire the pulse rate from the biometric information detection sensor, and the electric device applies pressure to the object such that the higher the pulse rate, the lower the maximum pressure, or conversely, the electric device applies pressure to the object such that the higher the pulse rate, the higher the maximum pressure.

According to such configuration, the operation pattern of the electric device can be set based on the biometric information such as the pulse rate and the body temperature; therefore, the entertainment value may be increased.

The interior member is not limited to a vehicle interior member constituting the interior of the vehicle, and for example, may be an interior member constituting an interior of a room. The vehicle interior member is not limited to an interior member of a car, and may, for example, be an interior member for other vehicles such as a ship or an aircraft.

When determining whether an object is located between the first portion and the second portion, it may be determined that there is an object located between the first portion and the second portion when both the condition that the sensor detects an object and the condition that the electric device is OFF are satisfied.

The character may be a character other than an animal, human, imaginary animal, animation character, or the like.

In the above-described embodiment, one electric device, one sensor, and one heater are provided for each of the first portion and the second portion. However, the electric device, the sensor, and the heater may be provided for only one of the first portion or the second portion. Further, the electric device, the sensor, and the heater may be arbitrary installed in either one of the first portion and the second portion. For example, the electric device may be provided in the first portion and the sensor and the heater may be provided in the second portion.

The projector may be mounted to the ceiling or door of the vehicle, the center console, or the seat.

The operation pattern of the electric device may be set according to the intimacy level between the occupant of the vehicle and the character displayed on the display, the carefulness of the driving, and other factors. For example, the operation pattern may be set so that the higher the intimacy level, the lower the pressure of the first portion and the second portion. Further, the operation pattern may be adjusted so that the more careful the driving, the lower the pressure of the first portion and the second portion. The intimacy level may be increased the more often the nibbling mode is executed. The carefulness of driving may be set such that it increases as an operating speed of at least one operation member for accelerator control, brake control, or steering wheel control becomes slower.

In the above-described embodiment, the side surfaces of the groove between the first portion and the second portion into which an object may be inserted are in close contact with each other. However, each of the side surfaces of the groove between the first portion and the second portion may be separated from each other. In other words, there may be a space between the two surfaces for nipping the object. In this case, it is preferable for the maximum distance between the two surfaces to be less than or equal to 2 cm. According to this configuration, small objects such as smartphones and fingers may be adequately nipped between the two surfaces.

The depth of the groove between the first portion and the second portion may be of a size that accommodate the first joint and the second joint of a finger.

The sensor may function as an operation input unit for operating the device. In other words, the controller may operate the device based on information from the sensor. The device may be an electric reclining mechanism for tilting the seat back, an electric sliding mechanism for sliding the seat in the front-rear direction or the lateral direction, a display, or the like.

The controller may operate an audio output unit (headrest speaker, in-car audio) in accordance with the operation of the electric device. For example, sound such as “chew chew” may be output in accordance with the motion of the first portion and the second portion nipping the finger.

The interior system or the interior member may comprise a fingerprint authentication unit. In this case, the controller may determine whether the user is a user registered in the fingerprint authentication unit based on information from the finger authentication unit, and the controller enables the nipping control in which an object is nipped between the first portion and the second portion if it is determined that the user is an registered user, and disables the nipping control if it is determined that the user is not a registered user. The registration of the fingerprint may be performed, for example, from the screen of the navigation system or the smartphone.

The number of times the nipping control is performed (for example, the number of times the pressure between the first portion and the second portion is increased and then is decreased) may be recorded, and the action of the character displayed on the display may be changed depending on the number. For example, as the number increases, the display may display a cat becoming stuffed, and the pressure between the first portion and the second portion may increase.

The following method is an example of a method for manufacturing the interior system.

A method for manufacturing an interior system is provided. The interior system includes an interior member that includes a first portion, a second portion configured to nip an object in combination with the first portion, an electric device that press at least one of the first portion or the second portion against the other one of the first portion or the second portion, a sensor that detects an object located between the first portion and the second portion, and a controller that controls the electric device based on information from the sensor. The controller is configured to cause at least one of the first portion or the second portion to be pressed against the other one of the first portion or the second portion when the controller determines that an object is located between the first portion and the second portion in a state where the electric device is not activated. The method for manufacturing the interior system includes a step of mounting the electric device on at least one of the first portion and the second portion, a step of mounting the sensor in a position capable of detecting the object, and a step of connecting the electric device and the sensor to the controller.

The following method is an example of a method for manufacturing the seat.

A method for manufacturing a seat is provided. The seat includes a pad and an outer covering with which the pad is covered, the pad including a first portion, a second portion adjacent to the first portion, and a groove formed between the first portion and the second portion into which the outer covering is tucked. The seat further includes an electric device that causes at least one of the first portion or the second portion to be pressed against the other one of the first portion or the second portion. The method for manufacturing the seat includes a step of disposing the electric device in the pad such that the electric device is disposed in a position corresponding to at least one of the first portion or the second portion.

In the method for manufacturing the seat, if the tuck-in groove is formed between a base portion located in a laterally central portion and a projecting portion disposed laterally outward of the base portion and which projects further toward the user side than the base portion, the electric device may be disposed in the base portion or the projecting portion.

The elements described in the above embodiment and its modifications may be implemented selectively and in combination.

1. A seat comprising:
a first electric device configured to operate when energized;
a second electric device configured to operate when energized;
a first operation unit configured to operate the first electric device; and
a controller configured to operate the first electric device based on a first operation command from the first operation unit
wherein the controller is configured to select and execute:
a first control, in response to receiving the first operation command from the first operation unit, in which the controller operates the first electric device in a first operation state corresponding to the first operation command, and
a second control, in response to receiving the first operation command from the first operation unit, in which the controller operates the first electric device in a second operation state that does not correspond to the first operation command and/or operates the second electric device.

2. The seat according to claim 1, wherein the first electric device is a mechanism configured to move a movable part between a first position and a second position, the movable part being at least a part of the seat
wherein the first operation command is a command to move the movable part from the first position to the second position,
wherein the controller is configured to:
move the movable part from the first position to the second position when executing the first control, and
move the movable part from the second position to the first position when executing the second control.

3. The seat according to claim 1, further comprising a third electric device,
wherein when the controller executes the second control in response to receiving the first operation command from the first operation unit, the controller is configured to operate the second electric device and the third electric device.

4. The seat according to claim 1, further comprising a switch configured to switch a mode of the controller between a first mode in which execution of the second control is disabled, and a second mode in which execution of the second control is enabled.

5. The seat according to claim 4, wherein the controller randomly selects the first control and the second control when the controller is in the second mode.

6. The seat according to claim 5,
wherein the controller is configured to execute a third control, in response to receiving the first operation command from the first operation unit, in which the first electric device is not operated, and
wherein the controller randomly selects the first control, the second control, and the third control when the controller is in the second mode.

7. A seat system comprising:
a seat according to claim 1; and
a display,
wherein the controller is configured to:
display a seat image representing the seat and a character image, and
move the character image in correspondence with the second operation state of the first electric device and/or an operation state of the second electric device when executing the second control.

8. The seat system according to claim 7, wherein the controller is configured to move the character image in correspondence with the first operation state of the first electric device when executing the first control.

9. A seat comprising:
an electric device configured to operate when energized;
an operation unit configured to operate the electric device; and
a controller configured to operate the electric device based on an operation command from the operation unit,
wherein the controller is configured to select and execute
a first control, in response to receiving the operation command from the operation unit, in which the controller operates the electric device in a first operation state corresponding to the operation command, and
a second control, in response to receiving the operation command from the operation unit, in which the controller operates the electric device in a second operation state that does not correspond to the operation command.

10. The seat according to claim 1, further comprising:
a first portion;
a second portion configured to nip an object in combination with the first portion;
a fourth electric device configured to cause at least one of the first portion or the second portion to be pressed against the other one of the first portion or the second portion; and
a sensor configured to detect an object located between the first portion and the second portion,
wherein the controller is configured to:
control the fourth electric device based on information from the sensor, and
operate the fourth electric device, when the controller determines that an object is located between the first portion and the second portion based on information from the sensor in a state where the fourth electric device is not operated, to cause at least one of the first portion or the second portion to be pressed against the other one of the first portion or the second portion.

11. A seat system comprising:
the seat according to claim 10; and
a display configured to display an animal character,
wherein the controller is configured to operate the fourth electric device in synchronization with a movement of a mouth of the animal character displayed on the display.

12. The seat according to claim 1, wherein the seat further comprises:
a pad; and
an outer covering with which the pad is covered,
wherein the pad comprises:
a first portion;
a second portion adjacent to the first portion; and
a groove formed between the first portion and the second portion, and into which the outer covering is tucked,
wherein the seat further comprises a fourth electric device configured to cause at least one of the first portion or the second portion to be pressed against the other one of the first portion or the second portion.

13. The seat according to claim 1, wherein the seat comprises:
a seat cushion; and
a seat back;
wherein the seat cushion comprises a first portion,
wherein the seat back comprises a second portion opposed to the first portion, and
wherein the seat further comprises a fourth electric device configured to cause at least one of the first portion or the second portion to be pressed against the other one of the first portion or the second portion.
